(19) United States
(12) Patent Application Publication
(10) Pub. No.: US 2021/0337481 A1
(43) Pub. Date: Oct. 28, 2021

(54) APPLICATION INFORMATION AIDED FAST DORMANCY

(71) Applicant: QUALCOMM Incorporated, San Diego, CA (US)

(72) Inventors: Satashu Goel, San Diego, CA (US); Ertugrul Necdet Ciftcioglu, San Diego, CA (US); Arvind Vardarajan Santhanam, San Diego, CA (US)

(21) Appl. No.: 17/237,957

(22) Filed: Apr. 22, 2021

Related U.S. Application Data
(60) Provisional application No. 63/014,396, filed on Apr. 23, 2020.
(60) Provisional application No. 63/014,368, filed on Apr. 23, 2020.

(51) Int. Cl. H04W 52/02; H04W 76/27; H04W 76/30; H04W 76/28

(52) U.S. Cl. CPC H04W 52/0274; H04W 52/0229; H04W 76/28; H04W 76/30; H04W 76/27

(57) ABSTRACT

Methods, systems, and devices for wireless communications are described. A user equipment (UE) operating in a connected mode may identify application usage information or UE operation information and may determine a preference to transition to an idle or inactive mode. Additionally, the UE may determine requested values for a set of parameters for a connected mode discontinuous reception (C-DRX) state of the UE. For example, the UE may predict a period of inactivity or determine the requested values based on a traffic profile, activity mode, or historical data. The UE may transmit, to a base station, an indication of the preference or an indication of the requested value. In response, the base station may instruct the UE to transition from the connected mode to the inactive or idle mode, or may transmit an indication of configured values for the set of parameters for the C-DRX state for the UE.

### CROSS REFERENCE

The present Application for Patent claims the benefit of U.S. Provisional Patent Application No. 63/014,396 by GOEL et al., entitled “APPLICATION INFORMATION AIDED FAST DORMANCY,” filed Apr. 23, 2020, and Application No. 63/014,368 by GOEL et al., entitled “APPLICATION INFORMATION-AIDED CONTINUOUS DISCONTINUOUS RECEPTION NEGOTIATION,” filed Apr. 23, 2020, assigned to the assignee hereof, and expressly incorporated by reference herein.

### FIELD OF TECHNOLOGY

The following relates generally to wireless communications and more specifically to application information aided fast dormancy.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A UE may operate in an operation state such as a radio resource control (RRC) state that is controlled by the network. The network may maintain an inactivity timer for the UE to transition from a connected state (e.g., an RRC connected state) to an inactive or idle state. The timer may be triggered after the most recent traffic occurs and may be reset if additional traffic occurs prior to the expiration of the timer. While the timer is running, however, the UE may maintain an active connection and monitor a control channel (e.g., a physical downlink control channel (PDCCH)) for downlink control information for the UE. Continuing to monitor the control channel for the duration of the timer may consume power at the UE which may lead to a reduced battery life, among other issues at the UE. However, the UE may be unable to receive traffic, such as low-latency traffic, while operating in an idle or inactive state.

### SUMMARY

The described techniques relate to improved methods, systems, devices, and apparatuses that support application information aided fast dormancy. Generally, the described techniques enable a user equipment (UE) to trigger a connection release before expiration of an inactivity timer maintained by the network. The triggering may be based on application usage information at the UE such that the UE uses application-specific information or UE operation information to predict or determine a period of inactivity at the UE. For example, the UE may determine that the battery is low and that an application operating on the UE spends relatively long periods of time without communicating with the network. In such instances, the UE may determine to initiate a shortened inactivity timer (e.g., a timer that is shorter than the network-maintained inactivity timer) after which the UE may transmit a message to the network indicating a preference of the UE to enter an inactive or idle mode. In response, a base station may transmit a connection release message to the UE instructing the UE to enter the inactive or idle mode prior to expiration of the network-maintained inactivity timer. By entering inactive or idle mode early (e.g., prior to expiration of the network-maintained inactivity timer), the UE may conserve power and extend the battery life, among other performance benefits.

Additionally, the described techniques relate to improved methods, systems, devices, and apparatuses that support application information aided connected discontinuous reception (DRX) negotiation. A UE may identify and provide optimal values for a connected mode DRX (C-DRX) state. Broadly, the optimal values may be based on the application(s) operating on the UE, the activity mode of the application(s), application usage information (e.g., historical usage data), and the like. The UE may identify or otherwise determine requested values for the set of parameters for the C-DRX state. The UE may identify or otherwise determine requested values for one or more of the ON duration, inactivity timer(s), short cycle duration(s), long cycle duration(s), number of short cycle(s), and the like, to be utilized when the UE is operating in the C-DRX state. Accordingly, the UE may transmit or otherwise convey an indication of the requested values for the C-DRX parameters to its serving base station. The base station may identify or otherwise determine configured values for the C-DRX state of the UE based on the requested values. For example, the base station may use the requested values when configuring the UE for the C-DRX state if possible, e.g., based on other network traffic conditions, resources availability, etc. The base station may transmit or otherwise provide a signal to the UE indicating the configured values for the C-DRX state, which may be utilized by the UE when operating in the C-DRX state. Accordingly, the UE may improve its C-DRX state operations according to the application usage information and/or activity mode for the application(s) operating on the UE.

A method of wireless communications at a UE is described. The method may include determining, by the UE operating in a connected mode, a preference for the UE to transition to an idle mode or an inactive mode based on application usage information of one or more applications operating on the UE, transmitting, to a base station, an indication of the preference for the UE to transition to the idle mode or the inactive mode, receiving, from the base station at least in part in response to the transmitted indication of the preference, a message instructing the UE to transition from the connected mode to the idle mode or the inactive mode, and operating in the idle mode or the inactive mode based on the received message.

An apparatus for wireless communications at a UE is described. The apparatus may include a processor, memory coupled with the processor, and instructions stored in the memory. The instructions may be executable by the processor to cause the apparatus to determine, by the UE operating in a connected mode, a preference for the UE to transition to an idle mode or an inactive mode based on application usage information of one or more applications operating on the UE, transmit, to a base station, an indication of the preference for the UE to transition to the idle mode or the inactive mode, receive, from the base station at least in part in response to the transmitted indication of the preference, a message instructing the UE to transition from the connected mode to the idle mode or the inactive mode, and operate in the idle mode or the inactive mode based on the received message.

Another apparatus for wireless communications at a UE is described. The apparatus may include means for determining, by the UE operating in a connected mode, a preference for the UE to transition to an idle mode or an inactive mode based on application usage information of one or more applications operating on the UE, transmitting, to a base station, an indication of the preference for the UE to transition to the idle mode or the inactive mode, receiving, from the base station at least in part in response to the transmitted indication of the preference, a message instructing the UE to transition from the connected mode to the idle mode or the inactive mode, and operating in the idle mode or the inactive mode based on the received message.

A non-transitory computer-readable medium storing code for wireless communications at a UE is described. The code may include instructions executable by a processor to determine, by the UE operating in a connected mode, a preference for the UE to transition to an idle mode or an inactive mode based on application usage information of one or more applications operating on the UE, transmit, to a base station, an indication of the preference for the UE to transition to the idle mode or the inactive mode, receive, from the base station at least in part in response to the transmitted indication of the preference, a message instructing the UE to transition from the connected mode to the idle mode or the inactive mode, and operate in the idle mode or the inactive mode based on the received message.

In some examples of the method, apparatuses, and non-transitory computer-readable medium described herein, transmitting the indication of the preference may include operations, features, means, or instructions for transmitting, via RRC signaling, UE assistance information that includes the indication of the preference.

In some examples of the method, apparatuses, and non-transitory computer-readable medium described herein, receiving the message may include operations, features, means, or instructions for receiving an RRC connection release message that instructs the UE to transition from the connected mode to the idle mode or the inactive mode.

Some examples of the method, apparatuses, and non-transitory computer-readable medium described herein may further include operations, features, means, or instructions for identifying application usage information of the one or more applications operating on the UE, initiating a first inactivity timer and a second inactivity timer based on the application usage information, the second inactivity timer longer than the first inactivity timer, and operating in the idle mode or the inactive mode after expiration of the first inactivity timer and before expiration of the second inactivity timer.

Some examples of the method, apparatuses, and non-transitory computer-readable medium described herein may further include operations, features, means, or instructions for determining an amount of increase in RRC signaling that will occur based on the UE transitioning to the idle mode or the inactive mode, and transmitting the indication of the preference based on the amount of the increase in RRC signaling being below a threshold.

Some examples of the method, apparatuses, and non-transitory computer-readable medium described herein may further include operations, features, means, or instructions for identifying application usage information of one or more applications operating on the UE, where the application usage information includes a name of the one or more applications, an identifier of the one or more applications, a foreground or background operation status of the one or more applications, a traffic profile of one or more applications, an activity mode of the one or more applications, or a combination thereof.

In some examples of the method, apparatuses, and non-transitory computer-readable medium described herein, the traffic profile of the one or more applications includes one or more of traffic burst statistics, packet size for one or more data packets, or a combination thereof.

In some examples of the method, apparatuses, and non-transitory computer-readable medium described herein, the activity mode of the one or more applications includes active traffic, web browsing, gaming, video streaming, music streaming, voice calling, virtual reality (VR), augmented reality (AR), or a combination thereof.

Some examples of the method, apparatuses, and non-transitory computer-readable medium described herein may further include operations, features, means, or instructions for determining UE operation information, where the preference for the UE to transition to the idle mode or the inactive mode may be based on the UE operation information.

In some examples of the method, apparatuses, and non-transitory computer-readable medium described herein, the UE operation information includes a number of active transmission control protocol connections, an amount of data for one or more transmissions by the UE or one or more receptions at the UE, a screen status of the UE, a battery status of the UE, a charging status of the UE, a wireless connectivity status of the UE, an increase in RRC signaling, or a combination thereof.

Some examples of the method, apparatuses, and non-transitory computer-readable medium described herein may further include operations, features, means, or instructions for receiving, at an RRC layer of the UE, the application usage information from an application layer of the UE.

Some examples of the method, apparatuses, and non-transitory computer-readable medium described herein may further include operations, features, means, or instructions for receiving, at a modem of the UE, the application usage information from an application processer of the UE, where the modem of the UE determines the preference for the UE to transition to the idle mode or the inactive mode and operates in the idle mode or the inactive mode based on the received message.

A method of wireless communication at a UE is described. The method may include determining requested values for a set of parameters for a C-DRX state of the UE, the requested values for the set of parameters based on application usage information and an activity mode of one or more applications operating on the UE, transmitting, to a base station, an indication of the requested values for the set of parameters, receiving, at least in part a response to the transmitted indication of the requested values for the set of parameters, a signal indicating configured values for the set of parameters for the C-DRX state for the UE, and operating in the C-DRX state according to the configured parameters.

An apparatus for wireless communication at a UE is described. The apparatus may include a processor, memory coupled with the processor, and instructions stored in the memory. The instructions may be executable by the processor to cause the apparatus to determine requested values for a set of parameters for a C-DRX state of the UE, the requested values for the set of parameters based on application usage information and an activity mode of one or more applications operating on the UE, transmit, to a base station, an indication of the requested values for the set of parameters, receive, at least in part a response to the transmitted indication of the requested values for the set of parameters, a signal indicating configured values for the set of parameters for the C-DRX state for the UE, and operate in the C-DRX state according to the configured parameters.

Another apparatus for wireless communication at a UE is described. The apparatus may include means for determining requested values for a set of parameters for a C-DRX state of the UE, the requested values for the set of parameters based on application usage information and an activity mode of one or more applications operating on the UE, transmitting, to a base station, an indication of the requested values for the set of parameters, receiving, at least in part a response to the transmitted indication of the requested values for the set of parameters, a signal indicating configured values for the set of parameters for the C-DRX state for the UE, and operating in the C-DRX state according to the configured parameters.

A non-transitory computer-readable medium storing code for wireless communication at a UE is described. The code may include instructions executable by a processor to determine requested values for a set of parameters for a C-DRX state of the UE, the requested values for the set of parameters based on application usage information and an activity mode of one or more applications operating on the UE, transmit, to a base station, an indication of the requested values for the set of parameters, receive, at least in part a response to the transmitted indication of the requested values for the set of parameters, a signal indicating configured values for the set of parameters for the C-DRX state for the UE, and operate in the C-DRX state according to the configured parameters.

Some examples of the method, apparatuses, and non-transitory computer-readable medium described herein may further include operations, features, means, or instructions for identifying the application usage information for each of the one or more applications operating on the UE, where determining the requested values for the set of parameters may be based on the application usage information.

Some examples of the method, apparatuses, and non-transitory computer-readable medium described herein may further include operations, features, means, or instructions for determining a first set of requested values for a first application of the one or more applications operating on the UE and a second set of requested values for a second application of the one or more applications operating on the UE, the first set of requested values being different from the second set of requested values, and determining the requested values based on the first set of requested values and the second set of requested values.

In some examples of the method, apparatuses, and non-transitory computer-readable medium described herein, determining the requested values for the set of parameters may include operations, features, means, or instructions for determining, for the UE, the requested values for the set of parameters based on the application usage information and at least one of transmission control protocol (TCP) information of the UE, or application preferred values, or a screen status, or a battery status, or a charging status, or a wireless connection status, or a combination thereof.

In some examples of the method, apparatuses, and non-transitory computer-readable medium described herein, the application usage information may be based on a traffic activity level, or a traffic type, or a priority level, or information received from an application processor, or an application type, or an application identifier, or a combination thereof, for each application.

Some examples of the method, apparatuses, and non-transitory computer-readable medium described herein may further include operations, features, means, or instructions for determining, for the one or more applications operation on the UE, a traffic profile based at least in part communications of the one or more applications, where the application usage information may be based on the determined traffic profile.

In some examples of the method, apparatuses, and non-transitory computer-readable medium described herein, the traffic profile of the one or more applications includes one or more of traffic burst statistics, packet size for one or more data packets, or any combination thereof.

In some examples of the method, apparatuses, and non-transitory computer-readable medium described herein, the activity mode of the one or more applications includes web browsing, gaming, video streaming, music streaming, video call, voice call, VR, AR, active state, or any combination thereof.

Some examples of the method, apparatuses, and non-transitory computer-readable medium described herein may further include operations, features, means, or instructions for determining that the activity mode may be associated with an activity level below a threshold value, identifying a set of inactivity timers and a set of cycle durations, the set of inactivity timers including at least a first inactivity timer and a second inactivity timer longer than the first inactivity timer, and the set of cycle durations including at least a first cycle duration and a second cycle duration longer than the first cycle duration, and selecting, based on the activity level below the threshold value, the first inactivity timer and the second cycle duration for the requested values.

Some examples of the method, apparatuses, and non-transitory computer-readable medium described herein may further include operations, features, means, or instructions for determining that the activity mode may be associated with an activity level that satisfies a threshold value, identifying a set of inactivity timers and a set of cycle durations, the set of inactivity timers including at least a first inactivity timer and a second inactivity timer longer than the first inactivity timer, and the set of cycle durations including at least a first cycle duration and a second cycle duration longer than the first cycle duration, and selecting, based on the activity level satisfying the threshold value, the second inactivity timer and the first cycle duration for the requested values.

In some examples of the method, apparatuses, and non-transitory computer-readable medium described herein, the set of parameters include at least one of an inactivity timer, or an ON duration, or a short cycle duration, or a long cycle duration, or a short cycle count, or a long cycle count, or a combination thereof, for the C-DRX state of the UE.

Some examples of the method, apparatuses, and non-transitory computer-readable medium described herein may further include operations, features, means, or instructions for receiving, at an RRC layer of the UE, the application usage information from an application layer of the UE.

Some examples of the method, apparatuses, and non-transitory computer-readable medium described herein may further include operations, features, means, or instructions for receiving, at a modem of the UE, the application usage information from an application processer of the UE, where the modem of the UE determines the requested values for the set of parameters and operates in the C-DRX state according to the configured parameters.

### BRIEF DESCRIPTION OF THE DRAWINGS

FIGS. 1 and 2 illustrate examples of wireless communications systems that support application information aided fast dormancy in accordance with aspects of the present disclosure.

FIG. 3 shows a block diagram of a device that supports application information aided fast dormancy in accordance with aspects of the present disclosure.

FIGS. 4A and 4B illustrate examples of timelines that support application information aided fast dormancy in accordance with aspects of the present disclosure.

FIG. 5 illustrates an example of a process flow that supports application information aided fast dormancy in accordance with aspects of the present disclosure.

FIG. 6 illustrates an example of a wireless communications system that supports application information aided fast dormancy in accordance with aspects of the present disclosure.

FIGS. 7 and 8 show block diagrams of devices that support application information aided fast dormancy in accordance with aspects of the present disclosure.

FIG. 9 illustrates an example of a process flow that supports application information aided fast dormancy in accordance with aspects of the present disclosure.

FIGS. 10 and 11 show block diagrams of devices that support application information aided fast dormancy in accordance with aspects of the present disclosure.

FIG. 12 shows a block diagram of a fast dormancy manager that supports application information aided fast dormancy in accordance with aspects of the present disclosure.

FIG. 13 shows a diagram of a system including a device that supports application information aided fast dormancy in accordance with aspects of the present disclosure.

FIGS. 14 and 15 show block diagrams of devices that support application information aided fast dormancy in accordance with aspects of the present disclosure.

FIG. 16 shows a block diagram of a connected discontinuous reception (C-DRX) adaptation manager that supports application information aided fast dormancy in accordance with aspects of the present disclosure.

FIG. 17 shows a diagram of a system including a device that supports application information aided fast dormancy in accordance with aspects of the present disclosure.

FIGS. 18 through 24 show flowcharts illustrating methods that support application information aided fast dormancy in accordance with aspects of the present disclosure.

### DETAILED DESCRIPTION

In conventional wireless communications systems, a user equipment (UE) may operate in an operation mode (e.g., a radio resource control (RRC) state) that is controlled by the network. For example, the UE may be in a connected mode (e.g., an RRC connected state) and may be in active communication with one or more base stations. The network may maintain an inactivity timer of a given time duration for the UE such that, after a period of inactivity, the UE may transition to an inactive mode (e.g., an RRC inactive state) or an idle mode (e.g., an RRC idle state). The timer may be initiated after the most recent traffic occurs and may reset if additional traffic occurs prior to the expiration of the timer. While the timer is running, the UE may monitor a control channel (e.g., a physical downlink control channel (PDCCH)), which may consume power at the UE and reduce battery life.

In some cases, the UE may transmit UE assistance information to a base station indicating that the UE prefers to transition to an inactive or idle state. In response, the base station may transmit an RRC connection release to the UE instructing the UE to transition to the inactive or idle state. The RRC connection release message may be transmitted by the base station after the inactivity timer expires. Waiting for the inactivity timer to expire may be power intensive, as the UE may monitor the PDCCH for the duration of the timer. Further, having a fixed (e.g., default) inactivity timer value may not take advantage of any traffic pattern observations corresponding to the UE.

To save power, the UE may trigger an early RRC connection release (e.g., transmit a preferred state indication to the base station) based on information available to the UE. The early release may be triggered based on information specific to one or more applications operating on the UE or on UE operation information. For example, the UE may use a traffic profile (e.g., traffic burst statistics) of an application and a screen status (e.g., whether the screen is inactive) to predict a duration of inactivity. If the predicted duration is above a threshold, the UE may determine a shortened inactivity timer (e.g., shorter than the inactivity timer maintained by the base station), initiate a shortened inactivity timer, or both, which may be used to request the RRC release without waiting for expiration of the network-maintained inactivity timer. Additionally or alternatively, the UE may determine, using the application information and operation information, to refrain from triggering the RRC release early. For example, the UE may determine an activity mode (e.g., video streaming, gaming) of the application and a wireless connectivity status (e.g., an active Bluetooth or hotspot connection), and may determine not to request the RRC release to avoid introducing latency (e.g., due to increased RRC signaling associated with requesting the RRC release). In any case, triggering the RRC release before the default inactivity timer expires may decrease the power consumption at the modem and may extend the lifetime of the battery, especially when background applications are operating on the UE with relatively infrequent traffic.

In some cases, the UE may monitor a wireless link continuously for an indication that the UE has downlink data to receive. In other cases (e.g., to conserve power and extend battery life) the UE may be configured with a discontinuous reception (DRX) cycle that includes one or more DRX states. A DRX cycle may consist of an active state (e.g., a connected state, which may also be referred to as an On Duration) where the UE may monitor for control information (e.g., on a PDCCH) and a sleep or idle state (e.g., an inactive or idle state where the UE may power down some of all of its radio components to conserve power. In some cases, a UE may be configured with a connected mode DRX (C-DRX) state where the UE powers down a portion of its radio components, but still maintains at least some degree of access stratum context with the base station, e.g., at least some degree of synchronization, timing, and the like.

In some cases, the UE may indicate a preferred DRX state using RRC signaling. For example, the UE assistance information may indicate that the UE would prefer to move to an active DRX state, or a C-DRX state, or an idle DRX state. In response, the base station may transmit the RRC connection release to the UE (e.g., using a legacy release) to transition the UE to the idle or inactive DRX state.

Aspects of the disclosure are initially described in the context of wireless communications systems. Generally, the described techniques provide various mechanisms for a UE to identify and provide optimal values for a C-DRX state. Broadly, the optimal values may be based on the application(s) operating on the UE, the activity mode of the application(s), application usage information, and the like. The UE may identify or otherwise determine requested values for the set of parameters for the C-DRX state. The UE may identify or otherwise determine requested values for one or more of the ON duration, inactivity timer(s), short cycle duration(s), long cycle duration(s), number of short cycle(s), and the like, to be utilized when the UE is operating in the C-DRX state. Accordingly, the UE may transmit or otherwise convey an indication of the requested values for the C-DRX parameters to its serving base station. The base station may identify or otherwise determine configured values for the C-DRX state of the UE based on the requested values. For example, the base station may use the requested values when configuring the UE for the C-DRX state if possible, e.g., based on other network traffic conditions, resources availability, etc. The base station may transmit or otherwise provide a signal to the UE indicating the configured values for the C-DRX state, which may be utilized by the UE when operating in the C-DRX state. Accordingly, the UE may improve its C-DRX state operations according to the application usage information and/or activity mode for the application(s) operating on the UE.

Aspects of the disclosure are initially described in the context of wireless communications systems. Additional aspects are described with reference to timelines and a process flow. Aspects of the disclosure are further illustrated by and described with reference to apparatus diagrams, system diagrams, and flowcharts that relate to application information aided fast dormancy or application information-aided C-DRX negotiation.

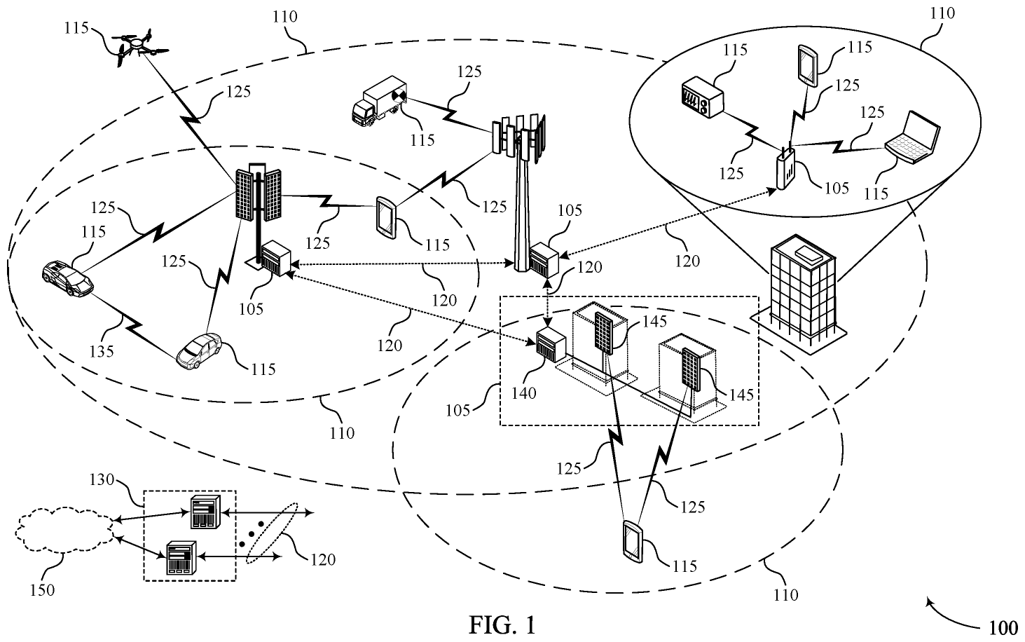

FIG. 1 illustrates an example of a wireless communications system 100 that supports application information aided fast dormancy in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 operating in an active or connected mode (e.g., an RRC connected mode or state) may determine a preference to enter an idle or inactive mode (e.g., an RRC inactive mode or state, or an RRC idle mode or state) based on information available to the UE 115. For example, the UE 115 may identify application usage information related to an application operating on the UE 115, and based on the application usage information, may transmit an indication of the preference to enter idle mode or inactive mode to a base station 105. The application usage information may include whether the application is running in the foreground or background at the UE, the traffic profile for the application (e.g., whether traffic bursts occurred or are occurring, data packet sizes of the traffic), historical usage data, or an activity mode of the application (e.g., whether the application is a game or used for web-browsing), among other information. In some cases, the UE 115 may utilize UE operation information such as power profile(s), a battery status, a screen status, or a charging status, among others, to determine a preference to enter idle or inactive mode. Once determined, the UE 115 may transmit a message indicating the UE preference to the base station 105. In response, the base station 105 may determine to transition the UE 115 from the connected mode to an idle or inactive mode by transmitting a connection release message to the UE 115.

Additionally, or alternatively, the UE 115 may determine requested values for a set of parameters for a C-DRX state of the UE 115, the requested values for the set of parameters based on the application usage information and the activity mode of one or more applications operating on the UE 115. The UE 115 may transmit, to the base station 105, an indication of the requested values for the set of parameters. The UE 115 may receive, in response to the transmitted indication of the requested values for the set of parameters, a signal indicating configured values for the set of parameters for the C-DRX state for the UE 115. The UE 115 may operate in the C-DRX state according to the configured parameters.

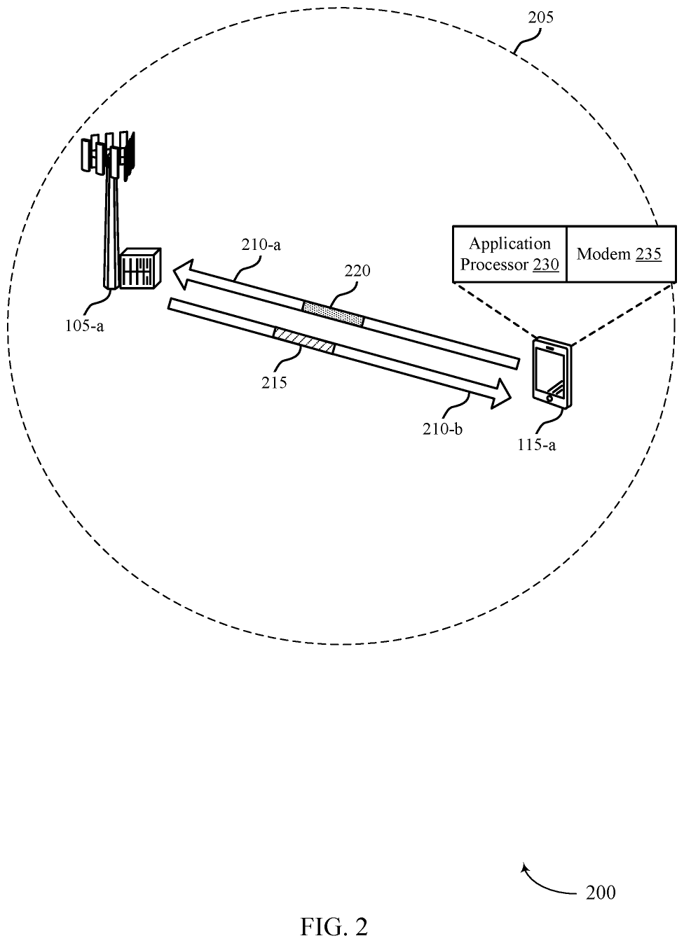

FIG. 2 illustrates an example of a wireless communications system 200 that supports application information aided fast dormancy in accordance with aspects of the present disclosure. In some examples, wireless communications system 200 may implement aspects of wireless communication system 100 and may include a UE 115-a, a base station 105-a with a coverage area 205, and communication links 210, which may be examples of the corresponding elements as described with reference to FIG. 1.

In wireless communications system 200, the UE 115-a may communicate with the base station 105-a using communication links 210. The UE 115-a may be in an active mode (e.g., in an RRC connected mode) and may be in active communication with the base station 105-a. In some cases, the UE 115-a may enter an inactive mode or idle mode. For example, if the UE 115-a is not receiving traffic from the base station 105-a, the UE 115-a may transition from connected mode to inactive or idle mode, which may enable the UE 115-a to save power (e.g., the UE 115-a is not monitoring PDCCH).

In some cases, the UE 115-a may identify a preference for an inactive or idle state and may request a release from the RRC connection from the base station 105-a. For example, the UE 115-a may transmit a preferred RRC state indication message 220 over an uplink communication link 210-a (e.g., the UE 115-a may transmit UE assistance information in a message to the base station 105-a, which may include an indication of a preference of the UE 115-a to transition to the inactive or idle state). The base station 105-a may transmit a connection release message 215 over a downlink communication link 210-b.

The determination to enter the inactive or idle mode may be based off of an inactivity timer (e.g., a default inactivity timer configured by a network), which may, in some cases, have a static value for its duration. That is, the UE 115-a or base station 105-a may trigger an inactivity timer after a traffic event has occurred, and if no further traffic events occur for the duration of the inactivity timer, the UE 115-a may enter inactive or idle mode. If traffic does occur prior to expiration of the timer, the timer may be reset. During the inactivity timer, the UE 115-a may monitor for control information (e.g., in a PDCCH), which may consume power. If the inactivity timer duration is a static value, the UE 115-a may monitor PDCCH for the entire duration, which may reduce the battery life at the UE 115-a. To conserve power, the UE 115-a may determine to enter an inactive or idle state prior to the expiration of the inactivity timer and may transmit the preferred RRC state indication message 220 to the base station 105-a requesting an RRC connection release.

As described herein, wireless communications system 200 may support the use of techniques that enable the UE 115-a to trigger an RRC connection release based on one or more applications operating at the UE 115-a, traffic patterns, other operating conditions at the UE 115-a, or any combination thereof. For instance, the UE 115-a may utilize application-specific information or UE operation information to predict an inactivity duration. Based on the information, the UE 115-a may determine to initiate a shortened inactivity timer (e.g., a timer shorter than the default inactivity timer), after which the UE 115-a may request the RRC connection release (e.g., by transmitting the preferred RRC state indication message 220 to the base station 105-a). As another example, the UE 115-a may use the application-specific information or UE operation information to determine to request the RRC connection release early, without waiting for the default inactivity timer or a shortened inactivity timer to expire.

The UE 115-a may include an application processor 230 and a modem 235, which may be used to determine whether the UE 115-a should enter an idle mode or an inactive mode. The application processor 230 and the modem 235 may determine application information and UE operation information. Application information may include, but is not limited to, an application identifier, an activity mode (e.g., active traffic, voice or video calls, web browsing, gaming), an application operation status (e.g., whether the application is running in the foreground or the background), a traffic profile (e.g., size of traffic bursts, distance between bursts), data activity (e.g., number of bytes transmitted or received by the UE 115-a), and transmission control protocol (TCP) information (e.g., number of TCP connections open or active), among other examples. UE operation information may include various status information, such as a battery status, charging status, screen status, Bluetooth or hotspot status, or any combination thereof.

The modem 235 may utilize the inputs from the application processor 230 and modem 235 to determine whether to transition to an inactive or idle mode. The modem 235 may determine a duration for a shortened inactivity timer, after which the UE 115-a may request the RRC connection release to enter the inactive or idle mode, or the modem 235 may determine to trigger the RRC connection release. For example, the application processor 230 may determine that an application running on the UE 115-a is operating in the background and that the screen status is inactive (e.g., that the user is not interacting with the UE 115-a). Accordingly, the modem 235 may predict that there may be an upcoming period of inactivity (e.g., a lack of traffic) and may begin a shortened inactivity timer. If no traffic is received or transmitted during the inactivity timer, the UE 115-a may transmit the preferred RRC state indication message 220 to the base station 105-a requesting an RRC connection release.

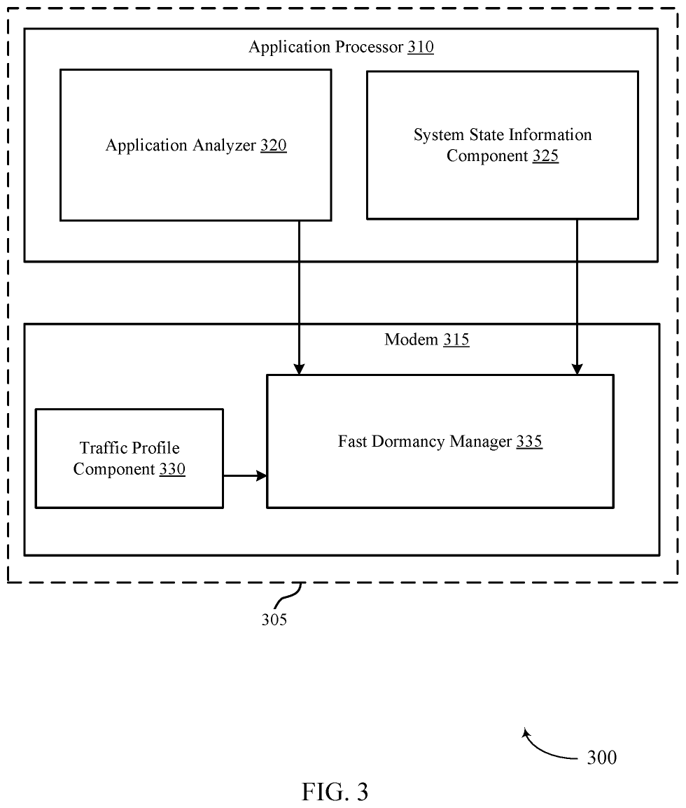

FIG. 3 shows a block diagram 300 of a device 305 that supports application information aided fast dormancy in accordance with aspects of the present disclosure. In some examples, device 305 may implement aspects of wireless communications systems 100 or 200. The device 305 may be a UE, such as a UE 115 as described with reference to FIGS. 1 and 2, and may include an application processor 310 and a modem 315. The application processor 310 and the modem 315 may determine whether the UE should enter an inactive or idle state. The modem 315 may receive application usage information from the application processor 310 and may determine a preference for the UE to transition to an inactive or idle mode. The modem 315 may include a fast dormancy manager 335, which may receive information from an application analyzer 320, a system state information component 325, and a traffic profile component 330. The fast dormancy manager 335 may use the information to determine a fast dormancy (e.g., shortened) inactivity timer setting or a decision to trigger an early RRC release.

The application analyzer 320 may analyze an application running on the device 305 and determine application-specific usage information inputs for the fast dormancy manager 335. Such usage information may include traffic information, data activity, historical data activity, activity modes, and whether the application is running in the foreground or background. Traffic information may include inter-arrival (e.g., time between data transmission or receptions) or burst statistics, such as sizes of bursts, time between bursts, or the like, as well as packet sizes for data packets. Data activity may include a number of bytes transmitted or received by the application. An activity mode, for example, may categorize the type of activity run by the application, such as web browsing or gaming. Other examples may include active traffic, video streaming, music streaming, voice calling, video calling, virtual reality (VR), or augmented reality (AR). The activity modes may, for example, include low activity and high activity modes (e.g., low activity being relatively lower than high activity modes) which may be determined by comparing activities to a threshold activity level, such as a threshold traffic level. The application analyzer 320 may assume an expected traffic pattern based on the activity mode. For example, a foreground application may indicate more frequent traffic, while an application running in the background may indicate infrequent traffic.

The system state information component 325 may determine UE operation information inputs for the fast dormancy manager 335, which may include TCP information, screen status, battery status, charging status, Bluetooth or hotspot status, or any combination thereof. Such status information may enable the fast dormancy manager 335 to determine a shortened inactivity timer duration. For instance, if the system state information component 325 indicates that the battery status is low or critical (e.g., below a threshold such as 10%, 20%, 30%, etc.) at the device 305, the fast dormancy manager 335 may determine to initiate a shortened inactivity timer or transmit an early RRC release request (e.g., via a UE assistance information message). Alternatively, the screen status may indicate whether the user is interacting with the device 305, in which case the fast dormancy manager 335 may determine not to enter the inactive or idle mode to avoid introducing latency (e.g., from increased RRC signaling associated with transmitting the RRC release request) while the user is active. Similarly, if a Bluetooth or hotspot connection is active, entering an inactive or idle state may terminate the Bluetooth or hotspot connection, which may increase latency at the device 305 to reestablish the connection and may reduce performance or user experience, among other issues.

TCP information indicated by the system state information component 325 may include, for example, a number of open or active TCP connections. As an example, if all TCP connections have terminated and no new connections are opened within a threshold period of time, the fast dormancy manager 335 may determine that existing traffic has been terminated and no new traffic is incoming. In such instances, the fast dormancy manager 335 may determine to request the RRC connection release early. In some cases, the period may be an application-specific threshold. For example, how long the fast dormancy manager 335 waits for new TCP connections to open may depend on the application.

The traffic profile component 330 may store or determine traffic profiles for one or more application operations on the device 305. Traffic profile information may include inter-arrival or burst statistics, packet sizes, traffic gap sizes, or the like. In some cases, one or more traffic profiles may be related to UE-specific historical data. For example, the traffic profile component may store historical data such as the type of data being communicated, the type of applications commonly running on the device 305, data activity related to the time of day, or which applications or data are most frequently present. In some other cases, traffic profiles may be based off of crowd-sourced statistics such as local or regional trends in applications operating on or communications performed by other devices. In some examples, each application may have an associated traffic profile.

The fast dormancy manager 335 may utilize information from the traffic profile component 330, the system state information component 325, and the application analyzer 320 to determine whether the device 305 should initiate a shortened inactivity timer or request an early RRC release to transition to inactive or idle mode. As an example, the fast dormancy manager 335 may determine, based on a traffic profile, activity mode, and screen status, that an application running on the device 305 will have an upcoming period of inactivity, and that the device 305 may save power by transitioning to an inactive or idle mode. The fast dormancy manager 335 may thus initiate the early RRC release request message.

In some examples, the fast dormancy manager 335 may be located in an RRC layer (e.g., an RRC protocol) and may receive the application usage information from an application layer of the device 305. The fast dormancy manager 335 may trigger the RRC connection release. In some other examples, the fast dormancy manager 335 may reside outside of the RRC layer and may signal the RRC layer to trigger the RRC release. The location of the fast dormancy manager 335 may depend on the location of sensors (e.g., battery sensors, screen sensors) used to provide inputs, which may be combined with application-specific information.

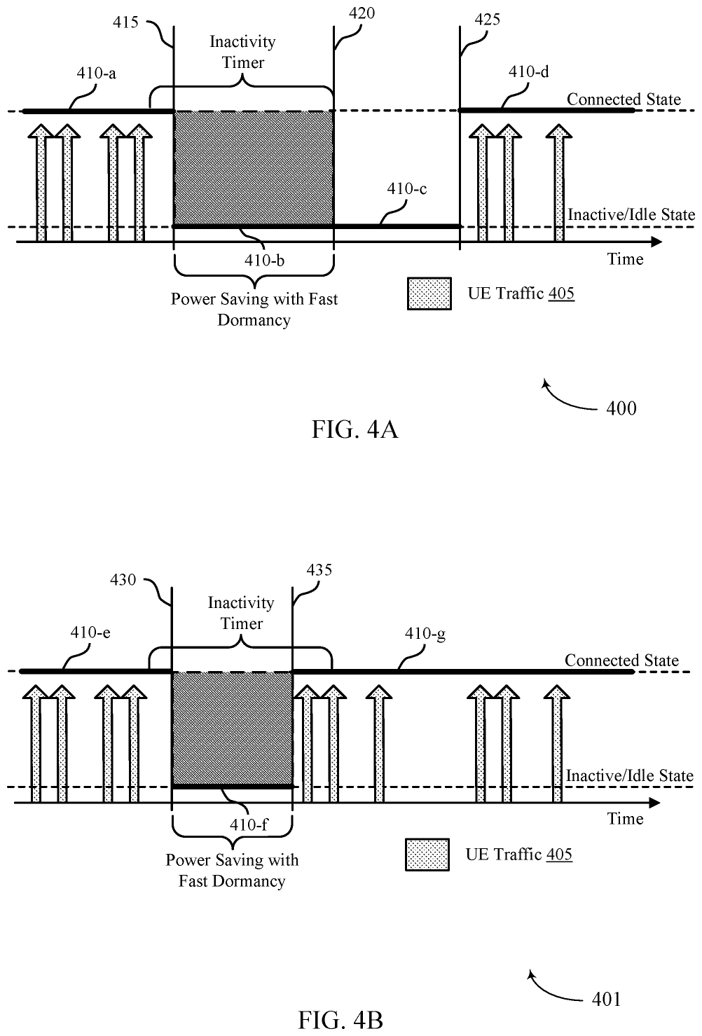

FIGS. 4A and 4B illustrate examples of a timeline 400 and a timeline 401 that support application information aided fast dormancy in accordance with aspects of the present disclosure. In some examples, the timeline 400 and the timeline 401 may implement aspects of wireless communications systems 100 or 200. For instance, the timeline 400 and the timeline 401 may illustrate communications between a UE and a base station, which may be examples of a UE 115 and base station 105, respectively, as described with reference to FIGS. 1 and 2. The timeline 400 and the timeline 401 may enable a wireless device to implement fast dormancy by using application information.

In FIG. 4A, a UE may be in an RRC state 410 (e.g., RRC connected mode) and may transmit or receive UE traffic 405. The UE may be in a connected state 410-a and may be transmitting or receiving bursts of UE traffic 405. As described herein, the UE may determine to transition to an inactive or idle mode (e.g., 410-b). A transition 415 and a transition 420 may be determined based on an inactivity timer or fast dormancy techniques. For example, the UE may utilize a network-configured default inactivity timer, which may begin counting after receiving a burst of traffic 405. The UE may wait for the inactivity timer to expire before transitioning (e.g., at 420) to an inactive or idle state 410-c.

Alternatively, the UE may determine a shortened (e.g., shorter than a default timer) inactivity timer based on a number of inputs or types of information as described herein, which may enable the UE to release the RRC connection and transition to the inactive or idle mode early (e.g., at transition 415, rather than at transition 420). As shown, the UE may save power during the time that would have otherwise elapsed between the transition 415 and the transition 420 (e.g., the end of the default inactivity timer), as the UE would have remained in connected mode to monitor for PDCCH during the elapsed time. The shortened inactivity timer may have a different time duration value than the default inactivity timer. For example, the shortened inactivity timer may be shorter than the default inactivity timer (e.g., by 5 seconds or by 8 seconds). In such examples, the UE power consumption may decrease (e.g., by 20%, 30%, etc.) by switching to the inactive or idle mode earlier. In cases where the UE spends a given amount of time (e.g., above a threshold amount of time) in a background or synchronization mode, power saving gains may increase.

At 425, the UE may determine to transition back to a connected state 410-d to receive (or transmit) upcoming UE traffic 405.

In FIG. 4B, the UE may receive (or transmit) traffic 405 while in a connected state 410-e. As described herein, an inactivity timer may begin after receiving a burst of traffic 405. If, however, the UE receives traffic 405 before the end of the inactivity timer, the inactivity timer may reset, and the UE may remain in the connected state 410-e. The UE may instead determine to release the RRC connection early and enter an inactive or idle mode 410-f at 430 using fast dormancy techniques as described herein. The UE may then transition back to a connected state 410-g at 435 to receive incoming traffic 405. In such cases, the inactivity timer (e.g., the network-maintained timer) used would not have expired by the time the next burst of traffic was received, and so the UE would, if using other methods, have remained in connected mode. By using fast dormancy to transition to the inactive or idle state 410-f for the elapsed time, the UE may save power that would otherwise have been spent monitoring for PDCCH in connected mode.

Triggering an early RRC release may increase the amount of RRC signaling between the UE and a base station as the UE transmits the release request and receives the corresponding message from the base station. In some cases, the UE may minimize an average modem power such that the increase in RRC signaling is less than a threshold. For example, the UE may refrain from using fast dormancy techniques if the power used in the corresponding increased RRC signaling is greater than the power that would be saved by an early RRC release.

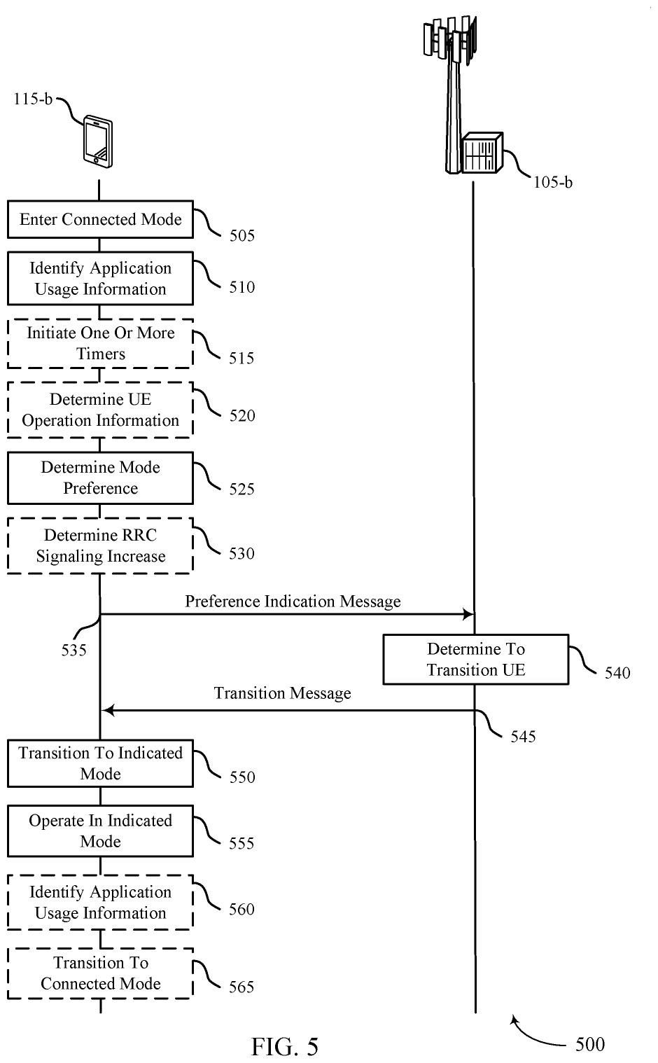

FIG. 5 illustrates an example of a process flow 500 that supports application information aided fast dormancy in accordance with aspects of the present disclosure. In some examples, process flow 500 may implement aspects of wireless communications systems 100 or 200 and may include a UE 115-b and a base station 105-b, which may be examples of the corresponding elements as described with reference to FIGS. 1 and 2. Alternative examples of the following may be implemented, where some processes are performed in a different order than described or are not performed at all. In some cases, processes may include additional features not mentioned below, or further processes may be added.

At 505, the UE 115-b may be operating in or may enter into a connected mode (e.g., an RRC connected mode) and may be in communication with the base station 105-b.

At 510, the UE 115-b may identify applications running on the UE 115-b and may identify corresponding usage information. For example, the UE 115-b may identify an application name or identifier, a traffic profile, an activity mode, or a foreground or background operation status, or any combination thereof. The traffic profile may include traffic burst statistics, a packet size for one or more data packets, or the like. The activity mode may include active traffic, gaming, web browsing, video streaming, music streaming, voice calling, video calling, VR, or AR, among other examples. In some cases, the application usage information may be transmitted from an application layer of the UE 115-b to an RRC layer of the UE 115-b. In some other cases, the application usage information may be transmitted from an application processor of the UE 115-b to a modem of the UE 115-b.

At 515, the UE 115-b may optionally initiate one or more inactivity timers. The timers may be based on the application usage information. In some cases, the UE 115-b may initiate a first inactivity timer and a second inactivity timer, where the second inactivity timer is longer than the first inactivity timer. The UE 115-b may operate in inactive or idle mode after the expiration of the first inactivity timer.

At 520, the UE 115-b may optionally determine UE operation information. For instance, the UE operation information may include a number of active TCP connections, an amount of data for the UE 115-b to transmit or receive, a wireless connectivity status, an increase in RRC signaling, or a screen status, charging status, or battery status of the UE 115-b, or any combination thereof.

At 525, the UE 115-b may, based on the application usage information and UE operation information, determine a mode preference. As an example, the UE 115-b may predict a duration of inactivity based on an application activity mode and a screen status and may determine a preference for transitioning to an inactive or idle mode. In some cases, the modem of the UE 115-b may determine the preference.

At 530, the UE 115-b may optionally determine an RRC signaling increase associated with a transition to the preferred mode. For example, the UE 115-b may determine that transitioning to the inactive or idle mode may result in an RRC signaling increase that is greater than the power saved by the transition. That is, the power utilized for the increased RRC signaling may be greater than the power saved from the UE 115-b transitioning to idle or inactive mode. Alternatively, the RRC signaling increase may be below an RRC signaling threshold.

At 535, the UE 115-b may transmit the determined preference in a preference indication message to the base station 105-b. For example, if the UE 115-b has determined a preference for operating in an inactive or idle mode, the preference indication message may include a request for an RRC connection release.

At 540, the base station 105-b may determine to transition the UE 115-b to the preferred mode.

At 545, the base station 105-b may transmit a message indicating that the UE 115-b may transition to the preferred state and may release the UE 115-b from the RRC connection.

At 550, the UE 115-b may transition to the indicated mode, and at 555, the UE 115-b may operate in the indicated mode.

At 560, the UE 115-b may optionally identify application usage information for an application running on the UE 115-b. For example, the UE 115-b may determine that an application is running in the foreground and that the screen status is active (e.g., a user is interacting with the UE 115-b).

At 565, based on the application usage information identified at 560, the UE 115-b may transition to and operate in a connected mode.

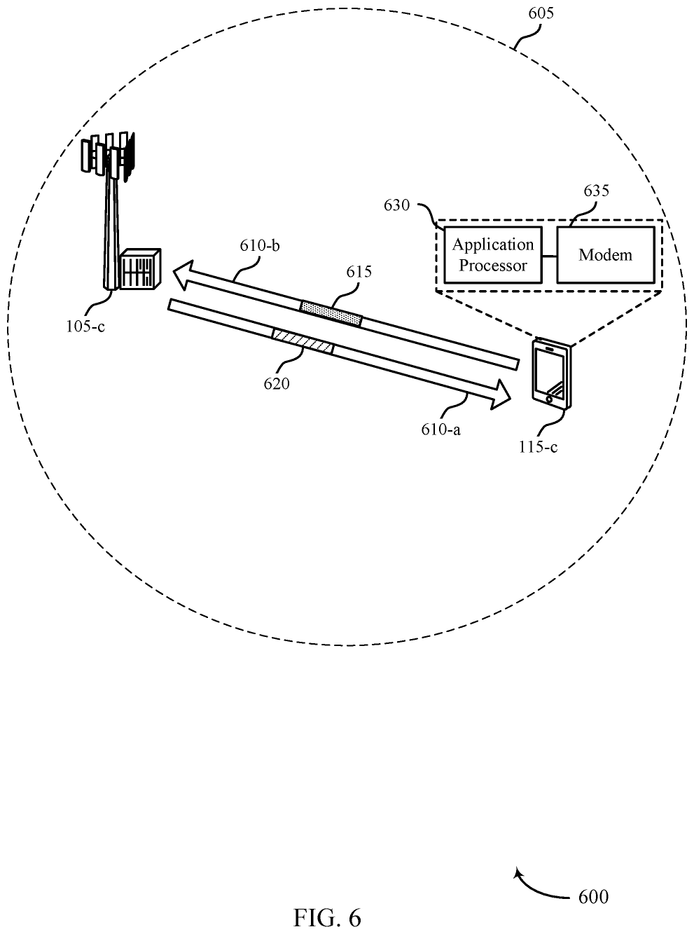

FIG. 6 illustrates an example of a wireless communication system 600 that supports application information-aided connected discontinuous reception negotiation in accordance with aspects of the present disclosure. In some examples, wireless communication system 600 may implement aspects of wireless communications systems 100 or 200 and may include a UE 115-c, a base station 105-c with a coverage area 605, and communication links 610, which may be examples of the corresponding devices and features described herein.

The UE 115-c may communicate with the base station 105-c using communication links 610. For example, the UE 115-c may receive downlink transmissions from the base station 105-c via the communication link 610-a and transmit uplink transmissions to the base station 105-c via the communication link 610-b.

In some aspects, the UE 115-c may monitor the communication link 610-a continuously for an indication from the base station 105-c that the UE 115-c has downlink data to receive. In other cases (e.g., to conserve power and extend battery life) the UE 115-c may be configured with a DRX cycle that includes one or more DRX states. A DRX cycle may consist of an active state (e.g., an RRC connected state, which may be referred to as an On Duration) where the UE 115-c may monitor for control information (e.g., on a PDCCH) and a sleep (e.g., inactive) or idle state where the UE 115-c may power down some of all of its radio components to conserve power. In some cases, the UE 115-c may be configured with a C-DRX state where the UE 115-c powers down a portion of its radio components, but still maintains at least some degree of access stratum context with the base station 105-c, e.g., at least some degree of synchronization in order to more quickly transition to the on duration or active state.

That is, the C-DRX state may conserve power consumption of the modem 635 of the UE 115-c to improve battery time. The C-DRX state may have an associated set of parameters that include, but are not limited to, an inactivity timer, an on duration, shorter- and long-cycle durations, the number of short cycles, and the like. The values utilized for these parameters typically involves a risk/reward trade-off. For example, the UE 115-c may be caught in a sleep mode of the C-DRX state when the network wants to transmit time-sensitive traffic. This may result in an unacceptable delay (e.g., increased latency) and/or result in an outage (e.g., in case of a buffer overflow). Conversely, the UE 115-c may consume excessive amounts of battery power if it the on durations of the C-DRX state are longer than is necessary.

In some cases, the UE 115-c may indicate a preferred DRX state using RRC signaling. That is, the UE 115-c may transmit a signal to the base station 105-c indicating which DRX state for which the UE 115-c prefers to be configured. For example, the UE 115-c may transmit, to the base station 105-c, UE assistance information indicating that the UE 115-c prefers to move to an active DRX state, or a C-DRX state, or an idle DRX state. In response, the base station 105-c may transmit an RRC connection release to the UE 115-c (e.g., using a legacy release) to transition the UE 115-c to the requested DRX state. As one non-limiting example, the UE 115-c may trigger an early RRC connection release based on application traffic identification. The UE 115-c may use application-specific information such as a traffic profile or context to predict a duration of inactivity. The UE 115-c may then trigger the RRC release in response. Triggering the RRC release early may decrease the power consumption of the modem 635 and may extend the lifetime of the battery, especially in an inactive usage scenario with background traffic.

Accordingly, aspects of the described techniques provide a mechanism for the UE 115-c to signal or request the optimal values for the DRX state according to the application(s) and data activity, e.g., application-based C-DRX negotiation. In addition to the active applications running or otherwise operating on the UE 115-c, the activity mode of such applications may also be utilized when identifying or otherwise determining the optimal values for the C-DRX parameters. Aspects of the described techniques may be implemented by the application processor 630 and/or the modem 635 of the UE 115-c, along with various other components, systems, functions, processes, and the like, of the UE 115-c.

The UE 115-c may include an application processor 630 and a modem 635. The application processor 630 and modem 635 may, collectively or independently, determine the requested values (e.g., the optimal values) for the set of parameters for the C-DRX state. For example, the application processor 630 may provide one or more variables with respect to the application usage information to the modem 635, or vice versa. The application processor 630 and/or the modem 635 may independently identify the application usage information inputs, or may be in communication with one or more layers of the UE 115-c, e.g., such as an RRC layer, an IP layer, and RLC layer, a MAC layer, a PDCP layer, and the like. In some aspects, the application processor 630 and/or the modem 635 may provide the inputs to a C-DRX adaptation algorithm, which provides outputs in the form of the requested values for the set of parameters of the C-DRX state.

The application processor 630 and/or the modem 635 may provide inputs (e.g., to a C-DRX adaptation algorithm) based on the application usage information and the activity mode that the UE 115-c is experiencing (or has been experiencing within a previous time period). Application usage information may include, but is not limited to, an application name/identifier, a data activity mode (e.g., web browsing vs. gaming), an application status (e.g., whether the application is running in the foreground or the background), a traffic profile (e.g., size of traffic bursts, distance between/periodicity of bursts), data activity (e.g., number of bytes transmitted or received), and TCP information (e.g., number of active/open TCP connections), among other examples. Some examples of the application usage information may include the application preferred C-DRX values, e.g., each application may have its own corresponding suggested or previously optimized values for the parameters of the C-DRX state operations.

The UE 115-c operational information (e.g., system state information) may include various status information, such as a battery status, charging status, screen status, or Bluetooth/hotspot status, and the like, for the UE 115-c. The UE 115-c may utilize the inputs to determine or otherwise identify requested values for the parameters (or set of parameters) for the C-DRX state. For example, the application processor 630, the modem 635, and/or one or more layers of the UE 115-c may provide the inputs to a C-DRX adaptation algorithm/manager that may be implemented in the application processor 630, the modem 635, or any other component, function, process, feature, etc., implemented in the UE 115-c in hardware and/or software. The output of the C-DRX adaptation algorithm/manager may be provided to the application processor 630, the modem 635, and/or any other component, function, or feature implemented on the UE 115-c in order to achieve aspects of the described techniques.

For example, the UE 115-c may determine a requested value for a duration for an inactivity timer (e.g., an inactivity timer duration value), a requested value for a duration of an on duration, a requested value for a short cycle duration, a requested value for a long cycle duration, a requested value for a number of short cycles, and the like. The UE 115-c may transmit or otherwise convey an indication 615 of the requested values for the parameters of the C-DRX state to a base station 105-c. For example, the UE 115-c may transmit the indication 615 in RRC signaling, in a MAC CE, an IP-based signaling, and the like, to the base station 105-c.

The activity mode for any given application operating on the UE 115-c may be based on the interactivity level of the application, web browsing, whether the application is running in the foreground or background, and the like. The activity mode may be indicated by the application processor 630 and/or may be inferred based on traffic activity.

By way of example only, the UE 115-c may select or otherwise determine a short inactivity timer and large DRX cycle duration for applications running in the background for the requested values for the C-DRX state. That is, the UE 115-c may determine that the activity mode is associated with an activity level below a threshold value. Accordingly, the UE 115-c may identify a set of inactivity timers (e.g., first and second inactivity timers, with the second inactivity timer duration being longer than the first inactivity timer) and a set of cycle durations (e.g., first and second cycle durations, with the second cycle duration being longer than the first cycle duration). The UE 115-c may select the first inactivity timer (e.g., the shorter duration inactivity timer) and the second cycle duration (e.g., the longer cycle duration) as the requested values.

As another example, the UE 115-c may select or otherwise determine a long inactivity timer and short DRX cycle for a gaming application for the C-DRX state. That is, the UE 115-c may determine that the activity mode is associated with an activity level that satisfies a threshold value. Accordingly, the UE 115-c may identify a set of inactivity timers (e.g., first and second inactivity timers, with the second inactivity timer duration being longer than the first inactivity timer) and a set of cycle durations (e.g., first and second cycle durations, with the second cycle duration being longer than the first cycle duration). The UE 115-c may select the second inactivity timer (e.g., the longer duration inactivity timer) and the second cycle duration (e.g., the shorter cycle duration) as the requested values.

Expressed in terms of a problem statement to minimize the modem 635 power of the UE 115-c, this may be expressed as: s.t. Delay (cost)<threshold, wherein threshold is application/activity mode specific. Minimization may be over the function C-DRX negotiator (Xₜ, t) that adapts the C-DRX parameters at time t. X may refer to the vector for all the features (e.g., inputs) at time t, e.g., past data activity. The average power may be over the traffic profile, e.g., depending on use case, collected log information, online data activity log, etc.

The base station 105-c may receive the indication 615 from the UE 115-c and, in response, transmit or otherwise convey the signal 620 indicating configured values for the set of parameters for the C-DRX state for the UE 115-c. The base station 105-c may receive the requested values from the UE 115-c and determine whether or not the requested values can be configured or adopted for the C-DRX state of the UE 115-c. The base station 105-c may consider the requested values in addition to other information (e.g., network status, network congestion levels, etc.) and, if possible, select the requested values as the configured values for the set of parameters for the C-DRX state of the UE 115-c. However, it is to be understood that in some examples the base station 105-c may utilize a portion, but perhaps not all, of the requested values as the configured values (e.g., when the base station 105-c has other information that make adopting all of the requested values not practical).

The UE 115-c may receive the signal 620 indicating the configured values for the set of parameters for the C-DRX state of the UE 115-c. The UE 115-c may then operate in the C-DRX state according to the configured parameters from the base station 105-c. That is, the UE 115-c may utilize the configured values for the set of parameters of the C-DRX state.

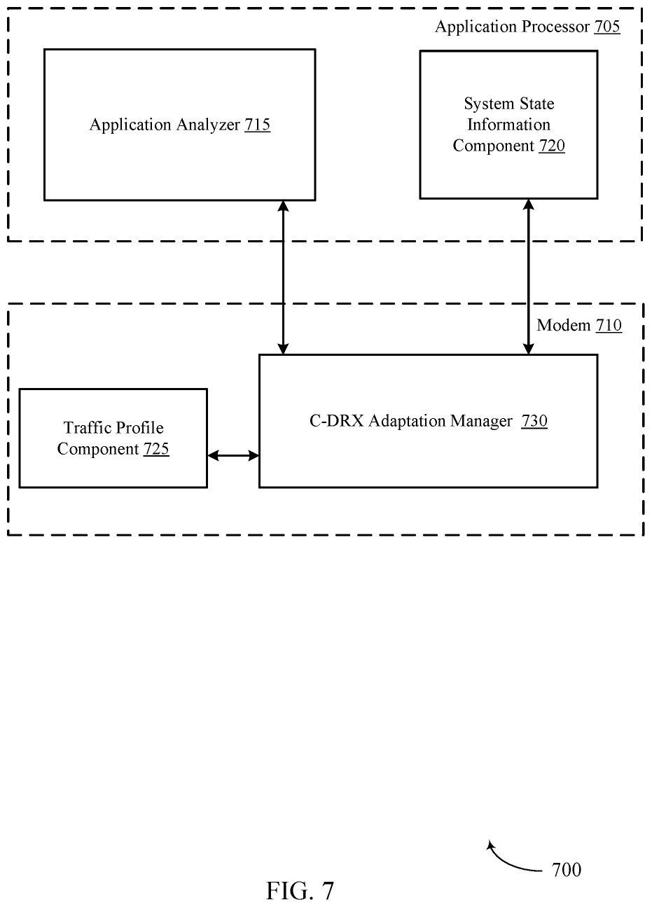

FIG. 7 illustrates an example of a block diagram 700 that supports application information-aided connected discontinuous reception negotiation in accordance with aspects of the present disclosure. In some examples, block diagram 700 may implement aspects of wireless communication systems 100 200, or 600. In some examples, the components illustrated in block diagram 700 may be a component, function, feature, and the like, of a UE, which may be an example of the corresponding devices described herein.

The UE may include an application processor 705 and a modem 710, which may be examples of the corresponding devices described herein. The application processor 705 may include an application analyzer 715 and a system state information component 720. The modem 710 may include traffic profile component 725 and C-DRX adaptation manager 730. Broadly, the application analyzer 715 and/or the system state information component 720 of the application processor 705, along with the traffic profile component 725, may provide inputs to the C-DRX adaptation manager 730. The inputs may refer to application usage information and activity mode for applications operating on the UE as well as system state information of the UE.

For example, the application analyzer 715 may analyze an application running on the UE and determine usage information inputs for the C-DRX adaptation manager 730. Such application usage information may be based on, or otherwise associated with, the traffic activity level, traffic type, priority level, application type, application identifier, or any other information received from the application processor 705, for the one or more applications operating on the UE. For example, the application analyzer 715 may receive traffic related information from the traffic profile component 725 of the modem 710 in order to determine the application usage information.

The system state information component 720 may determine UE operational information inputs, which may include the current screen status, battery status, charging status, Bluetooth/Wi-Fi/hot spot status, and the like for the UE. For example, the screen status may indicate whether the user is interacting with the UE, which may indicate whether or not the application is running and the background or foreground.

The traffic profile component 725 may correspond to the traffic activity level traffic type, etc., for the applications. For example, some applications may be associated with bursty traffic with long delays between each burst. Other applications may be associated with minimal traffic as the application operates in the background. Other examples may include applications associated with high traffic usage (e.g., lots of bursts and/or large packet sizes), such as gaming applications, video streaming, and the like. The traffic profile may also be associated with different reliability requirements, priority levels, latency requirements, throughput requirements, and the like.

The C-DRX adaptation manager 730 of the modem 710 may receive the inputs from the application analyzer 715, the system state information component 720, and/or the traffic profile component 725, and use the inputs to determine requested values for set of parameters for a C-DRX state of the UE. Broadly, the requested values for the set of parameters may be optimized based on the application/traffic pattern the UE is currently experiencing, expects to be implementing within a defined upcoming time window, and/or based on previous application/traffic patterns the UE has experienced (e.g., historical application data, historical traffic patterns). That is, the requested values output by the C-DRX adaptation manager 730 may be utilized by the UE to request values for a particular set of parameters for the C-DRX state based on the application usage information, activity mode, system status information, and the like, of the UE.

In some aspects, the requested values may be based on other parameters, such as the TCP information of the UE, an application preferred values, and the like, of the UE. For example, the application analyzer 715, the system state information component 720, and/or the traffic profile component 725, alone or in any combination, may determine the number of TCP connections the UE has that are active or open. The number of active TCP connections may be provided as one or more inputs to the C-DRX adaptation manager 730. The application preferred values may be information associated with a particular application. For example, some applications may be configured with a preferred or requested set of values for the set of parameters of the C-DRX state, which may be provided as inputs to the C-DRX adaptation manager 730. In another example, the application preferred requested set of values may correspond to metrics the UE has established for the application based on previous usage, e.g., previously optimized requested values for the application that performed within a defined tolerance level.

In some aspects, the traffic activity level may correspond to an amount of traffic communicated via the UE for the application within a time window. For example, the traffic activity level may correspond to the amount of traffic the application is associated with currently and/or within the last number of seconds, minutes, etc. The traffic type may generally refer to whether the traffic is bursty or not, is associated with a heavy data transfer (e.g., large amounts of data for packet sizes being communicated), and the like. Priority level for the application may correspond to a low priority level (e.g., for background applications), a high priority level (e.g., for applications associated with vehicle-based communications, emergency response communications, ultra-reliable/low latency communications (URLLC), and the like). The activity mode for the applications may correspond to whether the application is a web browsing application, gaming application, video streaming application, a music streaming have application, and the like. That is, an application type generally refers to the type of application operating on the UE, e.g., a video streaming application type vs. a web browsing application type, a gaming application type vs. an online shopping application type, etc. The activity mode of an application generally refers how the application is being used, e.g., browsing a video catalog vs. streaming a video, loading multiple pages vs. the user reading an article, etc. Further, the activity mode of an application may refer to the application running in the foreground vs. background, e.g., an open application that the user is interacting with vs. an application receiving content updates in the background.

The C-DRX adaptation manager 730 may receive the inputs and provide, as an output, an indication of requested values for the set of parameters for the C-DRX state of the UE. For example, the requested values may correspond to a requested value for an inactivity timer, on duration, short cycle duration, long cycle duration, a number of short cycles, and the like. As discussed, the requested values may be optimized based on the application usage information and activity mode for the applications running on the UE.

The UE may transmit an indication of the requested values for the set of parameters of the C-DRX state to a base station, which may respond with configured values for parameters of the C-DRX state for the UE. That is, the base station will receive or otherwise identify the requested values indicated from the UE, and use this information when configuring the C-DRX state for the UE. For example, a base station may adopt the requested values, if possible, and use these as the configured values for the C-DRX state for the UE. In another example, the base station may adopt a portion of the requested values as the configured values for the parameters of the C-DRX state for the UE to the extent allowed. For example, the base station may identify or otherwise determine network activity levels, congestion levels, error rates, a number of UEs associated with the base station, and the like, when configuring the C-DRX state for the UE. The base station may transmit a signal to the UE indicating the configured values for the parameters of the C-DRX state for the UE. The UE may adopt the configured values and operate in the C-DRX state accordingly.

Although the block diagram 700 illustrates one non-limiting example of how the described techniques may be implemented, it is to be understood that other configurations may also be utilized in accordance with the described techniques. For example, the application analyzer 715, the system state information component 720, the traffic profile component 725, and/or the C-DRX adaptation manager 730 may be implemented within the same component, system, function, process, and the like, of the UE. In other examples, such devices may be implemented at different layers (e.g., at protocol layer-1, layer-2, and/or layer-7) of the UE. Similarly, such components may be arranged differently (e.g., the traffic profile component 725 may be a sub-component of application processor 705). Accordingly, the described techniques may be implemented using the components illustrated a block diagram 700 in addition to various other components, modules, systems, functions, processes, features, and the like, arranged as illustrated or differently.

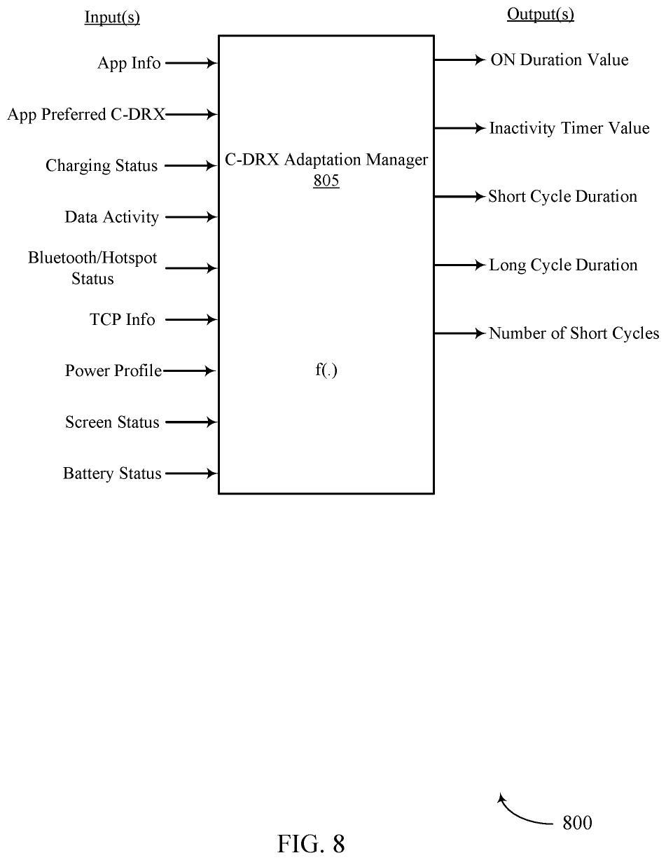

FIG. 8 illustrates an example of a block diagram 800 that supports application information-aided connected discontinuous reception negotiation in accordance with aspects of the present disclosure. In some examples, block diagram 800 may implement aspects of wireless communication systems 100, 200, or 600. Block diagram 800 generally illustrates a C-DRX adaptation manager 805, which may be an example of corresponding components described herein. For example, C-DRX adaptation manager 805 may be an example of C-DRX adaptation manager 730 described with reference to FIG. 7.

As described herein, C-DRX adaptation manager 805 may receive various inputs associated with applications operating on the UE and provide, as an output, requested values for a set of parameters for a C-DRX state of the UE. The inputs may be received from an application analyzer, system state information, traffic profiles, and the like, associated with the UE and/or the applications, for example, as described with reference to FIG. 7.

As illustrated in block diagram 800, the C-DRX adaptation manager 805 may receive inputs such as the application information, application preferred C-DRX values, charging status, power profiles, data activity, Bluetooth/hot spot status, TCP information, screen status, battery status, and the like. For example, the application information may refer to the application name/identifier, data activity for the application (e.g., such as the number of bytes transmitted and received by the application), whether the application is running in the foreground or background, a traffic profile for the application (e.g., inter-arrival/burst statistics, packet sizes, and the like), activity mode of the application (e.g., web browsing vs. gaming), and the like. The TCP information may refer to the number of active/open TCP connections the UE has established. The application preferred C-DRX values may correspond to values that are optimized for a particular application type. The data activity may correspond to the number of bytes transmitted and received by the application. The Bluetooth/hot spot status may generally refer to the status or mode (e.g., active or inactive, connected or disconnected, and the like) for any wireless connection of the UE. The battery status and charging status may refer to the current charge level of the battery, whether the phone is currently plugged in and charging or not, the life of the battery, and the like.

The C-DRX adaptation manager 805 may receive such inputs and provide outputs corresponding to the requested values for a set of C-DRX parameters. Examples of the requested values for the set of parameters for the C-DRX state of the UE may include, but are not limited to, a value for the on duration, a value for the inactivity timer, a value for the short cycle duration, a value for the long cycle duration, a value for the number of short cycle, and the like.

In some aspects, the C-DRX adaptation manager 805 may identify determine the requested values on a per-application basis. For example, the UE may determine a first set of requested values for a first application and a second set of requested values for a second application. The first set of requested values may be different from the second set of requested values. In this context, the UE may determine the requested values based at least in part on the first set of requested values and the second set of requested values, e.g., consider the requested values for each application to determine the actual requested values to be indicated to the base station.

In some aspects, the C-DRX adaptation manager 805 may implement the described techniques off-line (e.g., off-line optimization). For example, the C-DRX adaptation manager 805 may identify, receive, or otherwise determine, a data set collection for different use cases (e.g., video streaming, mapping applications, web browsing, mixed application uses, and the like). The C-DRX adaptation manager 805 may determine an optimal T_fast_dormancy that is fixed or adaptive, global or on a per-use case scenario, and the like. The C-DRX adaptation manager 805 may deploy the solution with the ability to enable/disable based on the metric performance (e.g., may update the requested values based on the performance of the current or previous C-DRX state of the UE).

In another example, the C-DRX adaptation manager 805 may perform online optimization (e.g., on the device, such as the UE). For example, the C-DRX adaptation manager 805 may, via one or more inputs, perform performance measurements. For example, the C-DRX adaptation manager 805 may measure the network configured inactivity timer (e.g., disable fast dormancy, measure the time between the last data activity and the RRC release). In another example, the C-DRX adaptation manager 805 may measure the performance with fast dormancy (e.g., measure the number of additional RRC connections if the data activity occurs after fast dormancy within T_network_inactivity_timer−T_fast_dormancy). The C-DRX adaptation manager 805 may measure the power savings by measuring the time in connected mode vs. idle mode (e.g., may model the C-DRX state based on the comparison). The C-DRX adaptation manager 805 may adapt the T_fast_dormancy (e.g., increase if the number of additional RRC connections are low/decrease if the number of additional RRC connections are high). Such adaptation may be performed on a global or per-use case.

Accordingly, the C-DRX adaptation manager 805 may output the requested values for the set of parameters for the C-DRX state of the UE. The UE may transmit the indication of the requested values to its base station, which may respond with a signal indicating configured values of the set of parameters for the C-DRX state of the UE. For example, the base station may adopt the requested values as the configured values of the C-DRX state, if practical. Accordingly, the UE may operate in the C-DRX state according to the configured values in an optimized manner to improve the risk/reward trade-off.

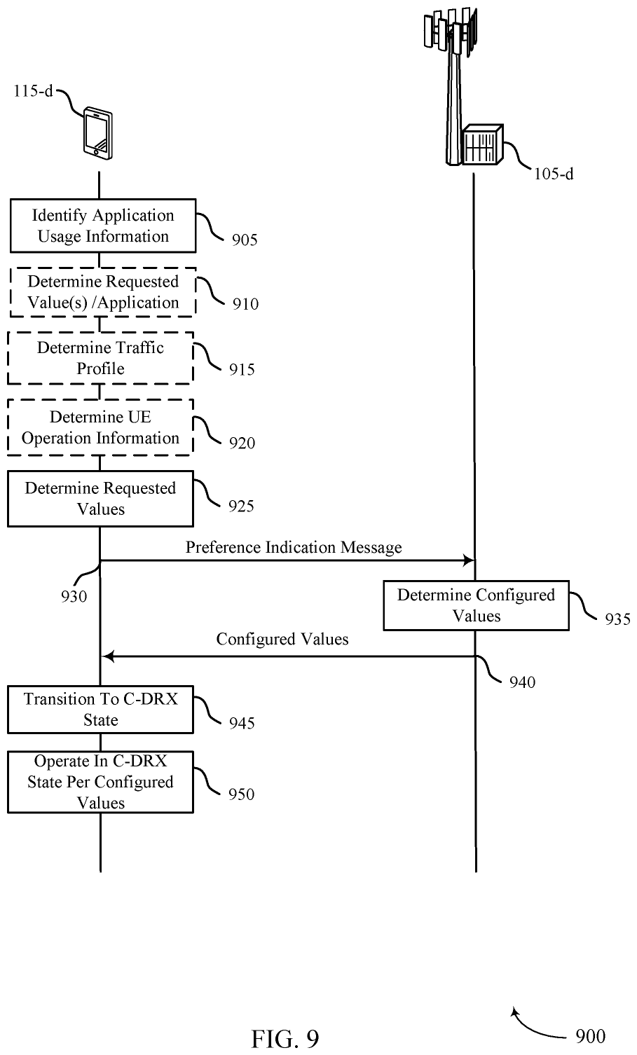

FIG. 9 illustrates an example of a process flow 900 that supports application information-aided connected discontinuous reception negotiation in accordance with aspects of the present disclosure. In some examples, process flow 900 may implement aspects of wireless communication systems 100, 200, or 600. Aspects of process flow 900 may be implemented by the UE 115-d and/or the base station 105-d, which may be examples of corresponding devices described herein.

At 905, the UE 115-d may identify application usage information for one or more applications operating on the UE 115-d. For example, an application processor (and/or information received from application processor) may provide the application usage information for the applications operating on the UE 115-d. Examples of the application usage information include, but are not limited to, application name/identifier, data activity, whether the applications are operating in the foreground or background, traffic profile for the application, activity mode of the application, and the like.

At 910, the UE 115-d may optionally determine application preferred requested values for the C-DRX state. For example, the UE 115-d may obtain the application preferred requested values from the application itself and/or based on requested values previously used for that application that performed at a level satisfying a threshold.

At 915, the UE 115-d may optionally determine a traffic profile for the one or more applications operating on the UE 115-d. In some examples, the traffic profile may be received at a modem from the application processor. Examples of the traffic profile include, but are not limited to, the inter-arrival/burst statistics, packet sizes, and the like.

At 920, the UE 115-d may optionally determine UE operational information (e.g., system state information). For example, the UE may determine its screen status, charging status, battery status, TCP information, power profile, Bluetooth/hot spot (or any other wireless connection) status, and the like for the UE 115-d.

At 925, the UE 115-d may determine the requested values for the set of parameters for the C-DRX state of the UE 115-d. Broadly, the requested values for the set of parameters may be based at least in part on the application usage information and an activity mode of the applications operating on the UE 115-d. For example, the UE 115-d may determine the requested values based on the application usage information, application preferred requested values, a traffic profile, UE operational information, and the like. Broadly, each requested value may correspond to an optimized value for a parameter of the C-DRX state (e.g., such as an optimized inactivity timer value, an optimized on duration value, and the like).

At 930, the UE 115-d may transmit (and the base station 105-d may receive) an indication of the requested values for the set of parameters for the C-DRX state. The UE 115-d may transmit the indication in a UE assistance request message, in RRC signaling, and the like.

At 935, the base station 105-d may determine the configured values for the C-DRX state for the UE 115-d. For example, the base station 105-d may simply adopt the requested values as the configured values for the parameters of the C-DRX state. In some examples, the base station 105-d may adopt a portion of the requested values as the configured values for the parameters of the C-DRX state. For example, the base station 105-d may consider the requested values in addition to other metrics, parameters, and the like, when determining whether to adopt the requested values as the configured values.

At 940, the base station 105-d may transmit (and the UE 115-d may receive) a signal indicating the configured values for the set of parameters for the C-DRX state for the UE 115-d. The base station 105-d may transmit the indication in an RRC release message that transitions the UE 115-d to the C-DRX state. In another example, the base station 105-d may transmit the indication separately from the RRC release message.

At 945, the UE 115-d may transition to the C-DRX state. For example, the UE 115-d may transition to the C-DRX state based on an RRC release message received from the base station 105-d. In another example, the UE 115-d may transition to the C-DRX state autonomously based on previously configured information from the base station 105-d.

At 950, the UE 115-d may operate in the C-DRX state according to the configured values. For example, the UE 115-d may utilize an on duration, inactivity timer, short cycle duration, long cycle duration, and/or number of short cycles while operating in the C-DRX state according to the configured values.

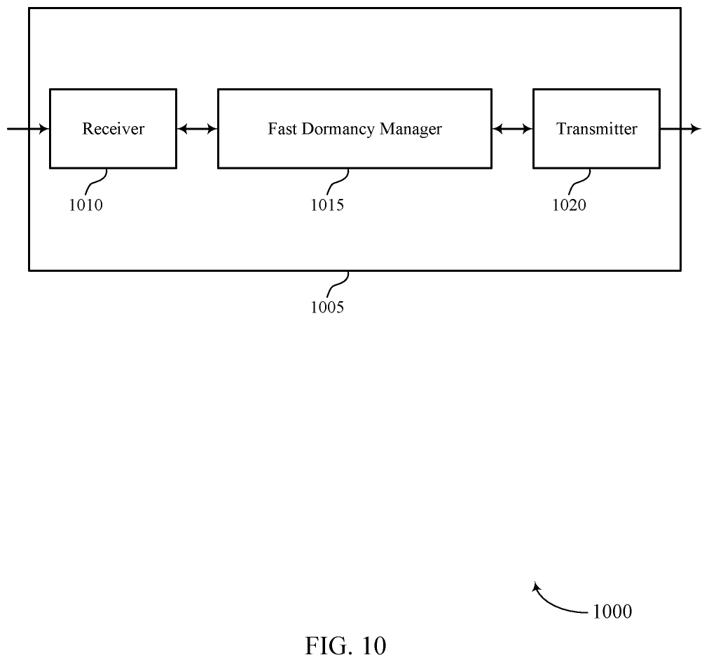

FIG. 10 shows a block diagram 1000 of a device 1005 that supports application information aided fast dormancy in accordance with aspects of the present disclosure. The device 1005 may be an example of aspects of a UE 115 as described herein. The device 1005 may include a receiver 1010, a fast dormancy manager 1015, and a transmitter 1020. The device 1005 may also include a processor. Each of these components may be in communication with one another (e.g., via one or more buses).

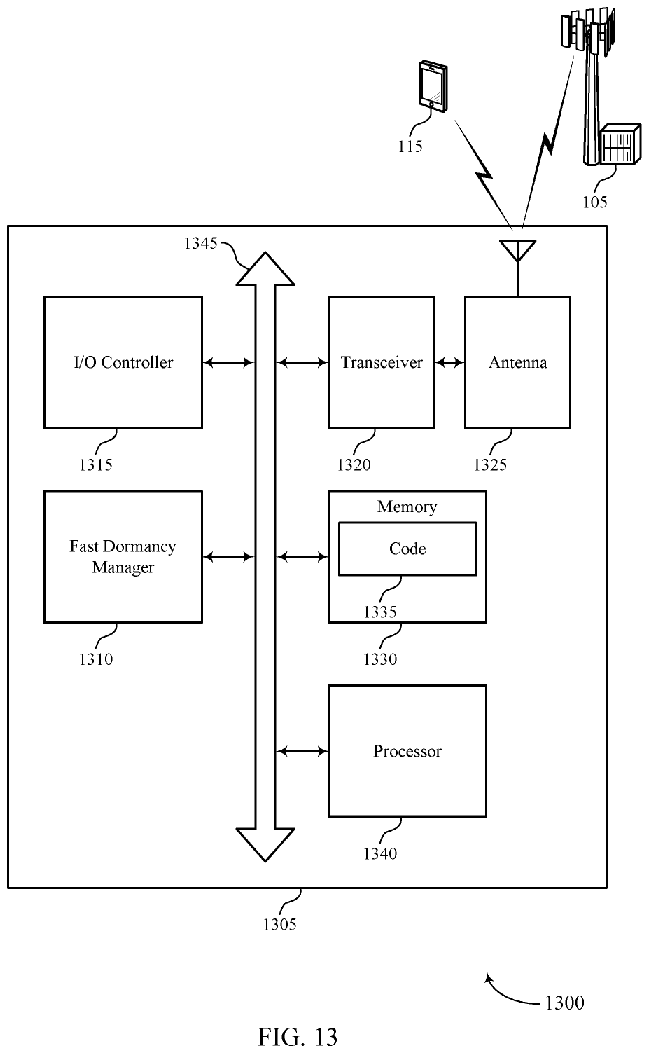

The receiver 1010 may receive information such as packets, user data, or control information associated with various information channels (e.g., control channels, data channels, and information related to application information aided fast dormancy, etc.). Information may be passed on to other components of the device 1005. The receiver 1010 may be an example of aspects of the transceiver 1320 described with reference to FIG. 13. The receiver 1010 may utilize a single antenna or a set of antennas.

The fast dormancy manager 1015 may determine, by the UE operating in a connected mode, a preference for the UE to transition to an idle mode or an inactive mode based on application usage information of one or more applications operating on the UE, transmit, to a base station, an indication of the preference for the UE to transition to the idle mode or the inactive mode, receive, from the base station at least in part in response to the transmitted indication of the preference, a message instructing the UE to transition from the connected mode to the idle mode or the inactive mode, and operate in the idle mode or the inactive mode based on the received message. The fast dormancy manager 1015 may be an example of aspects of the fast dormancy manager 1310 described herein.

The fast dormancy manager 1015, or its sub-components, may be implemented in hardware, code (e.g., software or firmware) executed by a processor, or any combination thereof. If implemented in code executed by a processor, the functions of the fast dormancy manager 1015, or its sub-components may be executed by a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described in the present disclosure.

The fast dormancy manager 1015, or its sub-components, may be physically located at various positions, including being distributed such that portions of functions are implemented at different physical locations by one or more physical components. In some examples, the fast dormancy manager 1015, or its sub-components, may be a separate and distinct component in accordance with various aspects of the present disclosure. In some examples, the fast dormancy manager 1015, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1020 may transmit signals generated by other components of the device 1005. In some examples, the transmitter 1020 may be collocated with a receiver 1010 in a transceiver module. For example, the transmitter 1020 may be an example of aspects of the transceiver 1320 described with reference to FIG. 13. The transmitter 1020 may utilize a single antenna or a set of antennas.

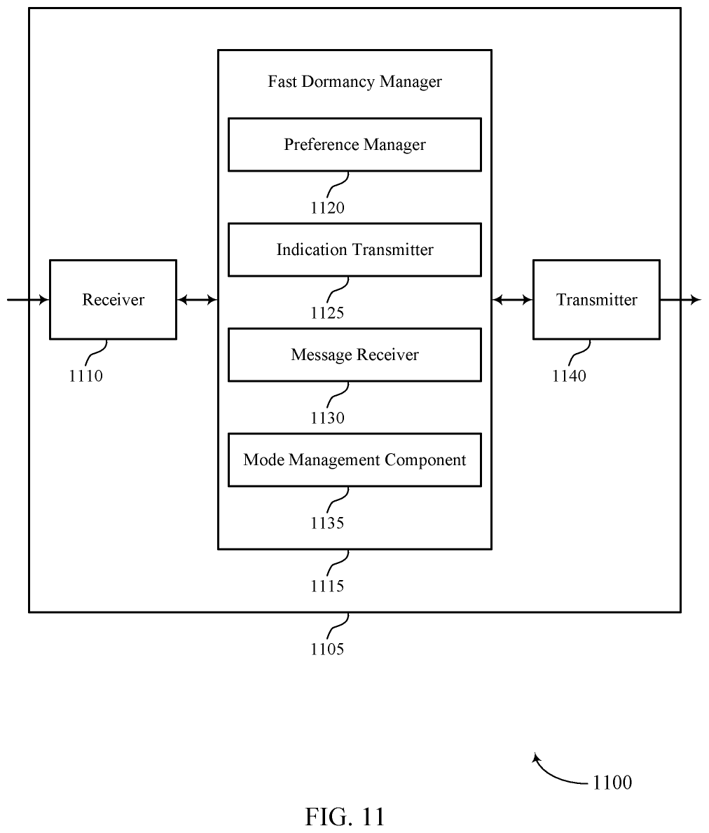

FIG. 11 shows a block diagram 1100 of a device 1105 that supports application information aided fast dormancy in accordance with aspects of the present disclosure. The device 1105 may be an example of aspects of a device 1005, or a UE 115 as described herein. The device 1105 may include a receiver 1110, a fast dormancy manager 1115, and a transmitter 1140. The device 1105 may also include a processor. Each of these components may be in communication with one another (e.g., via one or more buses).

The receiver 1110 may receive information such as packets, user data, or control information associated with various information channels (e.g., control channels, data channels, and information related to application information aided fast dormancy, etc.). Information may be passed on to other components of the device 1105. The receiver 1110 may be an example of aspects of the transceiver 1320 described with reference to FIG. 13. The receiver 1110 may utilize a single antenna or a set of antennas.

The fast dormancy manager 1115 may be an example of aspects of the fast dormancy manager 1015 as described herein. The fast dormancy manager 1115 may include a preference manager 1120, an indication transmitter 1125, a message receiver 1130, and a mode management component 1135. The fast dormancy manager 1115 may be an example of aspects of the fast dormancy manager 1310 described herein.

The preference manager 1120 may determine, by the UE operating in a connected mode, a preference for the UE to transition to an idle mode or an inactive mode based on application usage information of one or more applications operating on the UE.

The indication transmitter 1125 may transmit, to a base station, an indication of the preference for the UE to transition to the idle mode or the inactive mode.

The message receiver 1130 may receive, from the base station at least in part in response to the transmitted indication of the preference, a message instructing the UE to transition from the connected mode to the idle mode or the inactive mode.

The mode management component 1135 may operate in the idle mode or the inactive mode based on the received message.

The transmitter 1140 may transmit signals generated by other components of the device 1105. In some examples, the transmitter 1140 may be collocated with a receiver 1110 in a transceiver module. For example, the transmitter 1140 may be an example of aspects of the transceiver 1320 described with reference to FIG. 13. The transmitter 1140 may utilize a single antenna or a set of antennas.

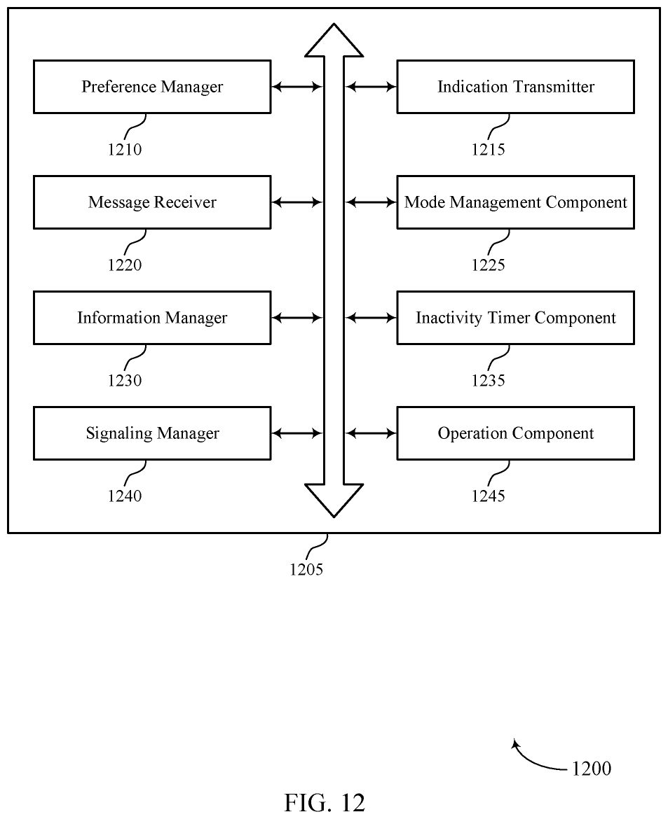

FIG. 12 shows a block diagram 1200 of a fast dormancy manager 1205 that supports application information aided fast dormancy in accordance with aspects of the present disclosure. The fast dormancy manager 1205 may be an example of aspects of a fast dormancy manager 1015, a fast dormancy manager 1115, or a fast dormancy manager 1310 described herein. The fast dormancy manager 1205 may include a preference manager 1210, an indication transmitter 1215, a message receiver 1220, a mode management component 1225, an information manager 1230, an inactivity timer component 1235, a signaling manager 1240, and an operation component 1245. Each of these modules may communicate, directly or indirectly, with one another (e.g., via one or more buses).

The preference manager 1210 may determine, by the UE operating in a connected mode, a preference for the UE to transition to an idle mode or an inactive mode based on application usage information of one or more applications operating on the UE.

The indication transmitter 1215 may transmit, to a base station, an indication of the preference for the UE to transition to the idle mode or the inactive mode.

In some examples, the indication transmitter 1215 may transmit, via RRC signaling, UE assistance information that includes the indication of the preference.

In some examples, the indication transmitter 1215 may transmit the indication of the preference based on the amount of the increase in RRC signaling being below a threshold.

The message receiver 1220 may receive, from the base station at least in part in response to the transmitted indication of the preference, a message instructing the UE to transition from the connected mode to the idle mode or the inactive mode.

In some examples, the message receiver 1220 may receive an RRC connection release message that instructs the UE to transition from the connected mode to the idle mode or the inactive mode.

The mode management component 1225 may operate in the idle mode or the inactive mode based on the received message.

In some examples, the mode management component 1225 may operate in the idle mode or the inactive mode after expiration of the first inactivity timer and before expiration of the second inactivity timer.

The information manager 1230 may identify application usage information of the one or more applications operating on the UE.

In some examples, identifying application usage information of one or more applications operating on the UE, where the application usage information includes a name of the one or more applications, an identifier of the one or more applications, a foreground or background operation status of the one or more applications, a traffic profile of one or more applications, an activity mode of the one or more applications, or a combination thereof.

In some examples, the information manager 1230 may receive, at an RRC layer of the UE, the application usage information from an application layer of the UE.

In some examples, the information manager 1230 may receive, at a modem of the UE, the application usage information from an application processer of the UE, where the modem of the UE determines the preference for the UE to transition to the idle mode or the inactive mode and operates in the idle mode or the inactive mode based on the received message.

In some cases, the traffic profile of the one or more applications includes one or more of traffic burst statistics, packet size for one or more data packets, or a combination thereof.

In some cases, the activity mode of the one or more applications includes active traffic, web browsing, gaming, video streaming, music streaming, voice calling, video calling, VR, AR, or a combination thereof.

The inactivity timer component 1235 may initiate a first inactivity timer and a second inactivity timer based on the application usage information, the second inactivity timer longer than the first inactivity timer.

The signaling manager 1240 may determine an amount of increase in RRC signaling that will occur based on the UE transitioning to the idle mode or the inactive mode.

The operation component 1245 may determine UE operation information, where the preference for the UE to transition to the idle mode or the inactive mode is based on the UE operation information.

In some cases, the UE operation information includes a number of active transmission control protocol connections, an amount of data for one or more transmissions by the UE or one or more receptions at the UE, a screen status of the UE, a battery status of the UE, a charging status of the UE, a wireless connectivity status of the UE, an increase in RRC signaling, or a combination thereof.

FIG. 13 shows a diagram of a system 1300 including a device 1305 that supports application information aided fast dormancy in accordance with aspects of the present disclosure. The device 1305 may be an example of or include the components of device 1005, device 1105, or a UE 115 as described herein. The device 1305 may include components for bi-directional voice and data communications including components for transmitting and receiving communications, including a fast dormancy manager 1310, an I/O controller 1315, a transceiver 1320, an antenna 1325, memory 1330, and a processor 1340. These components may be in electronic communication via one or more buses (e.g., bus 1345).

The fast dormancy manager 1310 may determine, by the UE operating in a connected mode, a preference for the UE to transition to an idle mode or an inactive mode based on application usage information of one or more applications operating on the UE, transmit, to a base station, an indication of the preference for the UE to transition to the idle mode or the inactive mode, receive, from the base station at least in part in response to the transmitted indication of the preference, a message instructing the UE to transition from the connected mode to the idle mode or the inactive mode, and operate in the idle mode or the inactive mode based on the received message.

The I/O controller 1315 may manage input and output signals for the device 1305. The I/O controller 1315 may also manage peripherals not integrated into the device 1305. In some cases, the I/O controller 1315 may represent a physical connection or port to an external peripheral. In some cases, the I/O controller 1315 may utilize an operating system such as iOS®, ANDROID®, MS-DOS®, MS-WINDOWS®, OS/2®, UNIX®, LINUX®, or another known operating system. In other cases, the I/O controller 1315 may represent or interact with a modem, a keyboard, a mouse, a touchscreen, or a similar device. In some cases, the I/O controller 1315 may be implemented as part of a processor. In some cases, a user may interact with the device 1305 via the I/O controller 1315 or via hardware components controlled by the I/O controller 1315.

The transceiver 1320 may communicate bi-directionally, via one or more antennas, wired, or wireless links as described herein. For example, the transceiver 1320 may represent a wireless transceiver and may communicate bi-directionally with another wireless transceiver. The transceiver 1320 may also include a modem to modulate the packets and provide the modulated packets to the antennas for transmission, and to demodulate packets received from the antennas.

In some cases, the wireless device may include a single antenna 1325. However, in some cases the device may have more than one antenna 1325, which may be capable of concurrently transmitting or receiving multiple wireless transmissions.

The memory 1330 may include RAM and ROM. The memory 1330 may store computer-readable, computer-executable code 1335 including instructions that, when executed, cause the processor to perform various functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting application information aided fast dormancy).

The code 1335 may include instructions to implement aspects of the present disclosure, including instructions to support wireless communications. The code 1335 may be stored in a non-transitory computer-readable medium such as system memory or other type of memory. In some cases, the code 1335 may not be directly executable by the processor 1340 but may cause a computer (e.g., when compiled and executed) to perform functions described herein.

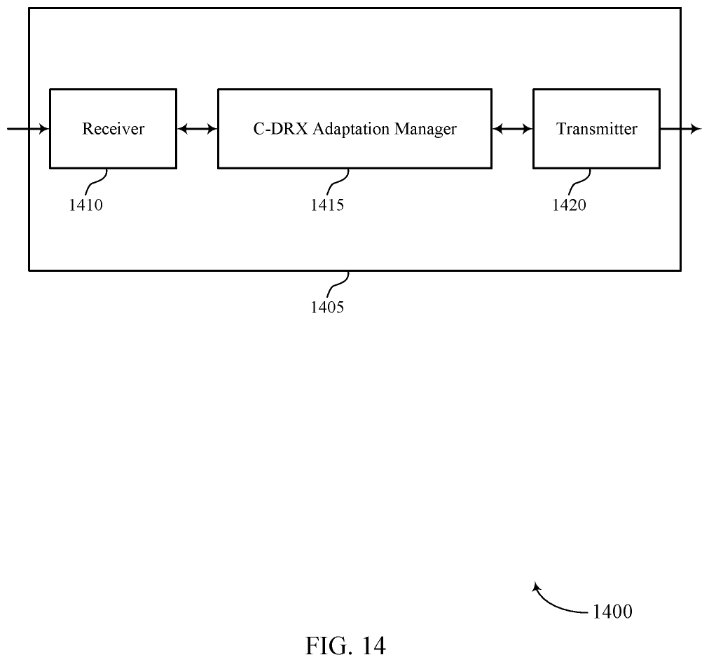

FIG. 14 shows a block diagram 1400 of a device 1405 that supports application information-aided connected discontinuous reception negotiation in accordance with aspects of the present disclosure. The device 1405 may be an example of aspects of a UE 115 as described herein. The device 1405 may include a receiver 1410, a C-DRX adaptation manager 1415, and a transmitter 1420. The device 1405 may also include a processor. Each of these components may be in communication with one another (e.g., via one or more buses).

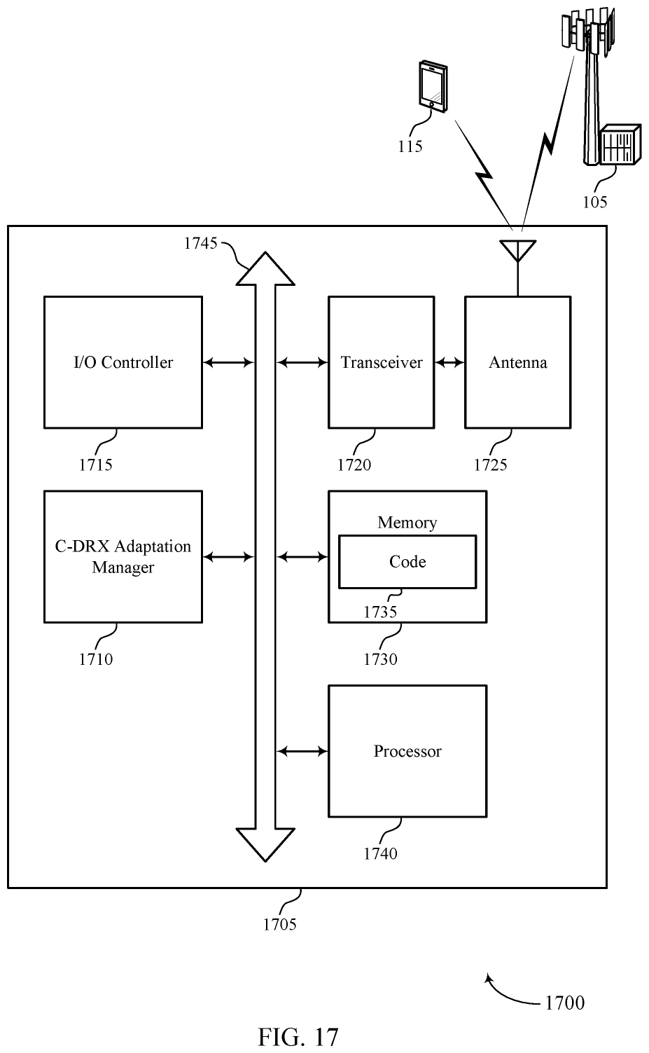

The receiver 1410 may receive information such as packets, user data, or control information associated with various information channels (e.g., control channels, data channels, and information related to application information-aided connected discontinuous reception negotiation, etc.). Information may be passed on to other components of the device 1405. The receiver 1410 may be an example of aspects of the transceiver 1720 described with reference to FIG. 17. The receiver 1410 may utilize a single antenna or a set of antennas.

The C-DRX adaptation manager 1415 may determine requested values for a set of parameters for a C-DRX state of the UE, the requested values for the set of parameters based on application usage information and an activity mode of one or more applications operating on the UE, transmit, to a base station, an indication of the requested values for the set of parameters, receive, at least in part a response to the transmitted indication of the requested values for the set of parameters, a signal indicating configured values for the set of parameters for the C-DRX state for the UE, and operate in the C-DRX state according to the configured parameters. The C-DRX adaptation manager 1415 may be an example of aspects of the C-DRX adaptation manager 1710 described herein.

The C-DRX adaptation manager 1415, or its sub-components, may be implemented in hardware, code (e.g., software or firmware) executed by a processor, or any combination thereof. If implemented in code executed by a processor, the functions of the C-DRX adaptation manager 1415, or its sub-components may be executed by a general-purpose processor, a DSP, an ASIC, an FPGA or other programmable logic device, discrete gate or transistor logic, discrete hardware components, or any combination thereof designed to perform the functions described in the present disclosure.

The C-DRX adaptation manager 1415, or its sub-components, may be physically located at various positions, including being distributed such that portions of functions are implemented at different physical locations by one or more physical components. In some examples, the C-DRX adaptation manager 1415, or its sub-components, may be a separate and distinct component in accordance with various aspects of the present disclosure. In some examples, the C-DRX adaptation manager 1415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1420 may transmit signals generated by other components of the device 1405. In some examples, the transmitter 1420 may be collocated with a receiver 1410 in a transceiver module. For example, the transmitter 1420 may be an example of aspects of the transceiver 1320 described with reference to FIG. 13. The transmitter 1420 may utilize a single antenna or a set of antennas.

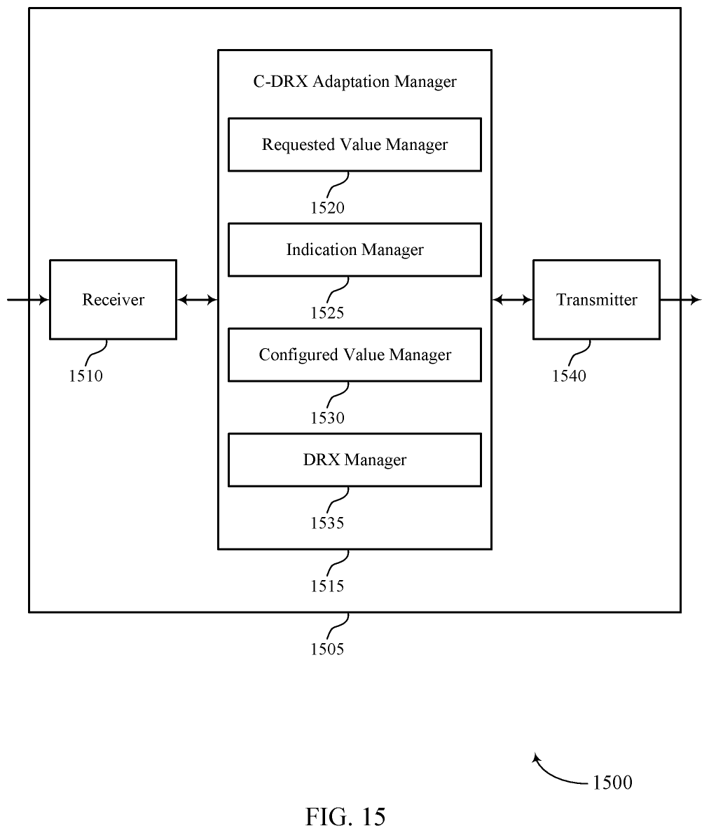

FIG. 15 shows a block diagram 1500 of a device 1505 that supports application information-aided connected discontinuous reception negotiation in accordance with aspects of the present disclosure. The device 1505 may be an example of aspects of a device 1405, or a UE 115 as described herein. The device 1505 may include a receiver 1510, a C-DRX adaptation manager 1515, and a transmitter 1540. The device 1505 may also include a processor. Each of these components may be in communication with one another (e.g., via one or more buses).

The receiver 1510 may receive information such as packets, user data, or control information associated with various information channels (e.g., control channels, data channels, and information related to application information-aided connected discontinuous reception negotiation, etc.). Information may be passed on to other components of the device 1505. The receiver 1510 may be an example of aspects of the transceiver 1720 described with reference to FIG. 17. The receiver 1510 may utilize a single antenna or a set of antennas.

The C-DRX adaptation manager 1515 may be an example of aspects of the C-DRX adaptation manager 1415 as described herein. The C-DRX adaptation manager 1515 may include a requested value manager 1520, an indication manager 1525, a configured value manager 1530, and a DRX manager 1535. The C-DRX adaptation manager 1515 may be an example of aspects of the C-DRX adaptation manager 910 described herein.

The requested value manager 1520 may determine requested values for a set of parameters for a C-DRX state of the UE, the requested values for the set of parameters based on application usage information and an activity mode of one or more applications operating on the UE.

The indication manager 1525 may transmit, to a base station, an indication of the requested values for the set of parameters.

The configured value manager 1530 may receive, at least in part a response to the transmitted indication of the requested values for the set of parameters, a signal indicating configured values for the set of parameters for the C-DRX state for the UE.

The DRX manager 1535 may operate in the C-DRX state according to the configured parameters.

The transmitter 1540 may transmit signals generated by other components of the device 1505. In some examples, the transmitter 1540 may be collocated with a receiver 1510 in a transceiver module. For example, the transmitter 1540 may be an example of aspects of the transceiver 1720 described with reference to FIG. 17. The transmitter 1540 may utilize a single antenna or a set of antennas.

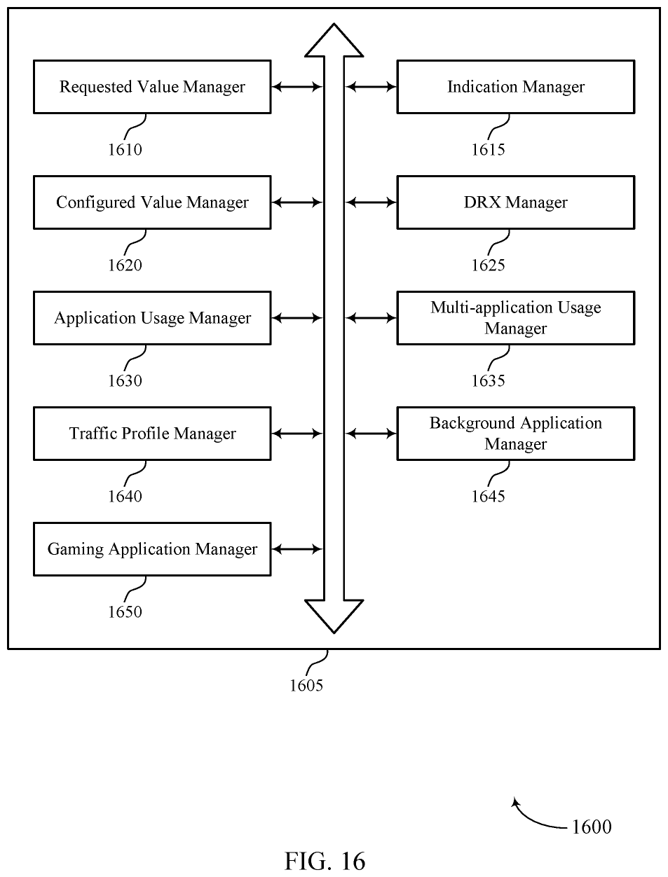

FIG. 16 shows a block diagram 1600 of a C-DRX adaptation manager 1605 that supports application information-aided connected discontinuous reception negotiation in accordance with aspects of the present disclosure. The C-DRX adaptation manager 1605 may be an example of aspects of a C-DRX adaptation manager 1415, a C-DRX adaptation manager 1515, or a C-DRX adaptation manager 1710 described herein. The C-DRX adaptation manager 1605 may include a requested value manager 1610, an indication manager 1615, a configured value manager 1620, a DRX manager 1625, an application usage manager 1630, a multi-application usage manager 1635, a traffic profile manager 1640, a background application manager 1645, and a gaming application manager 1650. Each of these modules may communicate, directly or indirectly, with one another (e.g., via one or more buses).

The requested value manager 1610 may determine requested values for a set of parameters for a C-DRX state of the UE, the requested values for the set of parameters based on application usage information and an activity mode of one or more applications operating on the UE. In some examples, the requested value manager 1610 may determine, for the UE, the requested values for the set of parameters based on the application usage information and at least one of TCP information of the UE, or application preferred values, or a screen status, or a battery status, or a charging status, or a wireless connection status, or a combination thereof.

In some examples, the requested value manager 1610 may receive, at an RRC layer of the UE, the application usage information from an application layer of the UE. In some examples, the requested value manager 1610 may receive, at a modem of the UE, the application usage information from an application processer of the UE, where the modem of the UE determines the requested values for the set of parameters and operates in the C-DRX state according to the configured parameters. In some cases, the application usage information is based on a traffic activity level, or a traffic type, or a priority level, or information received from an application processor, or an application type, or an application identifier, or a combination thereof, for each application.

In some cases, the activity mode of the one or more applications includes web browsing, gaming, video streaming, music streaming, video call, voice call, VR, AR, active state, or any combination thereof. In some cases, the set of parameters include at least one of an inactivity timer, or an ON duration, or a short cycle duration, or a long cycle duration, or a short cycle count, or a long cycle count, or a combination thereof, for the C-DRX state of the UE.

The indication manager 1615 may transmit, to a base station, an indication of the requested values for the set of parameters.

The configured value manager 1620 may receive, at least in part a response to the transmitted indication of the requested values for the set of parameters, a signal indicating configured values for the set of parameters for the C-DRX state for the UE.

The DRX manager 1625 may operate in the C-DRX state according to the configured parameters.

The application usage manager 1630 may identify the application usage information for each of the one or more applications operating on the UE, where determining the requested values for the set of parameters is based on the application usage information.

The multi-application usage manager 1635 may determine a first set of requested values for a first application of the one or more applications operating on the UE and a second set of requested values for a second application of the one or more applications operating on the UE, the first set of requested values being different from the second set of requested values. In some examples, the multi-application usage manager 1635 may determine the requested values based on the first set of requested values and the second set of requested values.

The traffic profile manager 1640 may determine, for the one or more applications operation on the UE, a traffic profile based at least in part communications of the one or more applications, where the application usage information is based on the determined traffic profile. In some cases, the traffic profile of the one or more applications includes one or more of traffic burst statistics, packet size for one or more data packets, or any combination thereof.

The background application manager 1645 may determine that the activity mode is associated with an activity level below a threshold level. In some examples, the background application manager 1645 may identify a set of inactivity timers and a set of cycle durations, the set of inactivity timers including at least a first inactivity timer and a second inactivity timer longer than the first inactivity timer, and the set of cycle durations including at least a first cycle duration and a second cycle duration longer than the first cycle duration. In some examples, the background application manager 1645 may select, based on the activity level below the threshold value, the first inactivity timer and the second cycle duration for the requested values.

The gaming application manager 1650 may determine that the activity mode is associated with an activity level that satisfies a threshold value. In some examples, the gaming application manager 1650 may identify a set of inactivity timers and a set of cycle durations, the set of inactivity timers including at least a first inactivity timer and a second inactivity timer longer than the first inactivity timer, and the set of cycle durations including at least a first cycle duration and a second cycle duration longer than the first cycle duration. In some examples, the gaming application manager 1650 may select, based on the activity level satisfying the threshold, the second inactivity timer and the first cycle duration for the requested values.

FIG. 17 shows a diagram of a system 1700 including a device 1705 that supports application information-aided connected discontinuous reception negotiation in accordance with aspects of the present disclosure. The device 1705 may be an example of or include the components of device 1405, device 1505, or a UE 115 as described herein. The device 1705 may include components for bi-directional voice and data communications including components for transmitting and receiving communications, including a C-DRX adaptation manager 1710, an I/O controller 1715, a transceiver 1720, an antenna 1725, memory 1730, and a processor 1740. These components may be in electronic communication via one or more buses (e.g., bus 1745).

The C-DRX adaptation manager 1710 may determine requested values for a set of parameters for a C-DRX state of the UE, the requested values for the set of parameters based on application usage information and an activity mode of one or more applications operating on the UE, transmit, to a base station, an indication of the requested values for the set of parameters, receive, at least in part a response to the transmitted indication of the requested values for the set of parameters, a signal indicating configured values for the set of parameters for the C-DRX state for the UE, and operate in the C-DRX state according to the configured parameters.

The I/O controller 1715 may manage input and output signals for the device 1705. The I/O controller 1715 may also manage peripherals not integrated into the device 1705. In some cases, the I/O controller 1715 may represent a physical connection or port to an external peripheral. In some cases, the I/O controller 1715 may utilize an operating system such as iOS®, ANDROID®, MS-DOS®, MS-WINDOWS®, OS/2®, UNIX®, LINUX®, or another known operating system. In other cases, the I/O controller 1715 may represent or interact with a modem, a keyboard, a mouse, a touchscreen, or a similar device. In some cases, the I/O controller 1715 may be implemented as part of a processor. In some cases, a user may interact with the device 1705 via the I/O controller 1715 or via hardware components controlled by the I/O controller 1715.

The transceiver 1720 may communicate bi-directionally, via one or more antennas, wired, or wireless links as described above. For example, the transceiver 1720 may represent a wireless transceiver and may communicate bi-directionally with another wireless transceiver. The transceiver 1720 may also include a modem to modulate the packets and provide the modulated packets to the antennas for transmission, and to demodulate packets received from the antennas.

In some cases, the wireless device may include a single antenna 1725. However, in some cases the device may have more than one antenna 1725, which may be capable of concurrently transmitting or receiving multiple wireless transmissions.

The memory 1730 may include RAM and ROM. The memory 1730 may store computer-readable, computer-executable code 1735 including instructions that, when executed, cause the processor to perform various functions described herein. In some cases, the memory 1730 may contain, among other things, a basic input/output system (BIOS) which may control basic hardware or software operation such as the interaction with peripheral components or devices.

The processor 1740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1740 may be configured to operate a memory array using a memory controller. In other cases, a memory controller may be integrated into the processor 1740. The processor 1740 may be configured to execute computer-readable instructions stored in a memory (e.g., the memory 1730) to cause the device 1705 to perform various functions (e.g., functions or tasks supporting application information-aided connected discontinuous reception negotiation).

The code 1735 may include instructions to implement aspects of the present disclosure, including instructions to support wireless communications. The code 1735 may be stored in a non-transitory computer-readable medium such as system memory or other type of memory. In some cases, the code 1735 may not be directly executable by the processor 1740 but may cause a computer (e.g., when compiled and executed) to perform functions described herein.

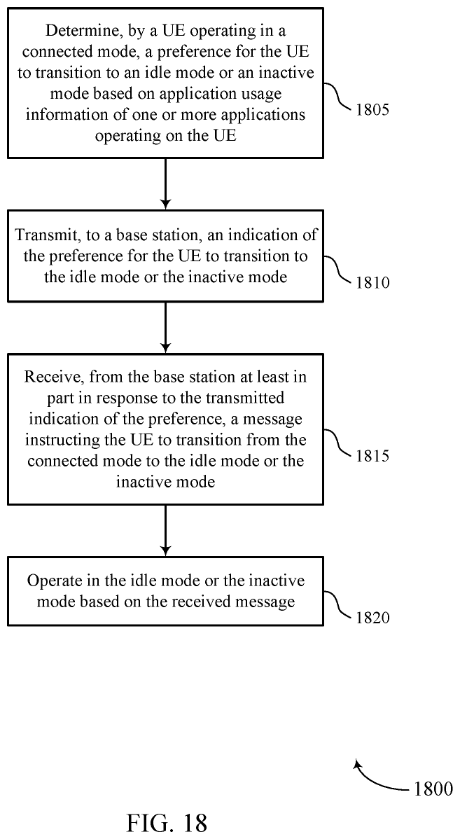

FIG. 18 shows a flowchart illustrating a method 1800 that supports application information aided fast dormancy in accordance with aspects of the present disclosure. The operations of method 1800 may be implemented by a UE 115 or its components as described herein. For example, the operations of method 1800 may be performed by a fast dormancy manager as described with reference to FIGS. 10 through 13. In some examples, a UE may execute a set of instructions to control the functional elements of the UE to perform the functions described herein. Additionally or alternatively, a UE may perform aspects of the functions described herein using special-purpose hardware.

At 1805, the UE may determine, by the UE operating in a connected mode, a preference for the UE to transition to an idle mode or an inactive mode based on application usage information of one or more applications operating on the UE. The operations of 1805 may be performed according to the methods described herein. In some examples, aspects of the operations of 1805 may be performed by a preference manager as described with reference to FIGS. 10 through 13.

At 1810, the UE may transmit, to a base station, an indication of the preference for the UE to transition to the idle mode or the inactive mode. The operations of 1810 may be performed according to the methods described herein. In some examples, aspects of the operations of 1810 may be performed by an indication transmitter as described with reference to FIGS. 10 through 13.

At 1815, the UE may receive, from the base station at least in part in response to the transmitted indication of the preference, a message instructing the UE to transition from the connected mode to the idle mode or the inactive mode. The operations of 1815 may be performed according to the methods described herein. In some examples, aspects of the operations of 1815 may be performed by a message receiver as described with reference to FIGS. 10 through 13.

At 1820, the UE may operate in the idle mode or the inactive mode based on the received message. The operations of 1820 may be performed according to the methods described herein. In some examples, aspects of the operations of 1820 may be performed by a mode management component as described with reference to FIGS. 10 through 13.

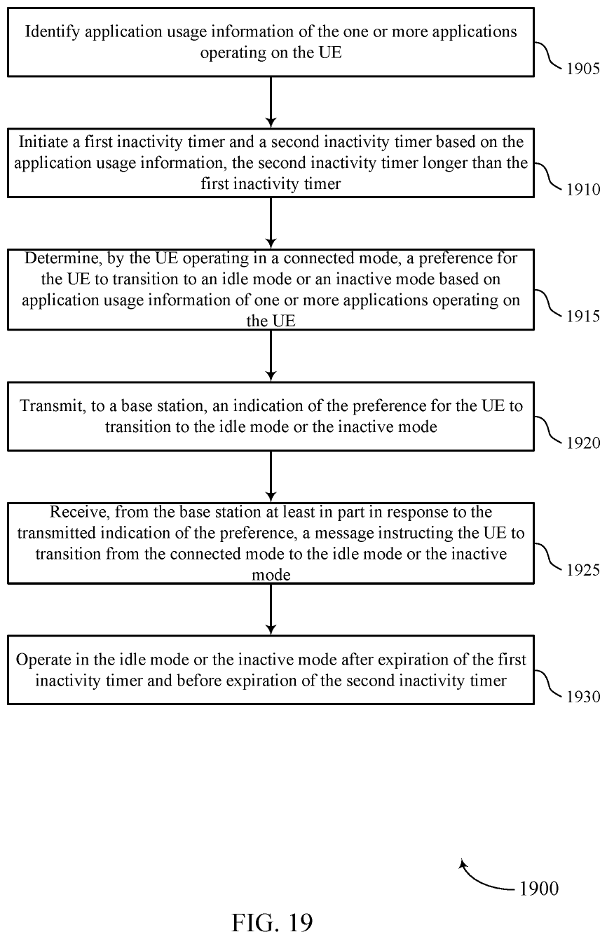

FIG. 19 shows a flowchart illustrating a method 1900 that supports application information aided fast dormancy in accordance with aspects of the present disclosure. The operations of method 1900 may be implemented by a UE 115 or its components as described herein. For example, the operations of method 1900 may be performed by a fast dormancy manager as described with reference to FIGS. 10 through 13. In some examples, a UE may execute a set of instructions to control the functional elements of the UE to perform the functions described herein. Additionally or alternatively, a UE may perform aspects of the functions described herein using special-purpose hardware.

At 1905, the UE may identify application usage information of the one or more applications operating on the UE. The operations of 1905 may be performed according to the methods described herein. In some examples, aspects of the operations of 1905 may be performed by an information manager as described with reference to FIGS. 10 through 13.

At 1910, the UE may initiate a first inactivity timer and a second inactivity timer based on the application usage information, the second inactivity timer longer than the first inactivity timer. The operations of 1910 may be performed according to the methods described herein. In some examples, aspects of the operations of 1910 may be performed by an inactivity timer component as described with reference to FIGS. 10 through 13.

At 1915, the UE may determine, by the UE operating in a connected mode, a preference for the UE to transition to an idle mode or an inactive mode based on application usage information of one or more applications operating on the UE. The operations of 1915 may be performed according to the methods described herein. In some examples, aspects of the operations of 1915 may be performed by a preference manager as described with reference to FIGS. 10 through 13.

At 1920, the UE may transmit, to a base station, an indication of the preference for the UE to transition to the idle mode or the inactive mode. The operations of 1920 may be performed according to the methods described herein. In some examples, aspects of the operations of 1920 may be performed by an indication transmitter as described with reference to FIGS. 10 through 13.

At 1925, the UE may receive, from the base station at least in part in response to the transmitted indication of the preference, a message instructing the UE to transition from the connected mode to the idle mode or the inactive mode. The operations of 1925 may be performed according to the methods described herein. In some examples, aspects of the operations of 1925 may be performed by a message receiver as described with reference to FIGS. 10 through 13.

At 1930, the UE may operate in the idle mode or the inactive mode after expiration of the first inactivity timer and before expiration of the second inactivity timer. The operations of 1930 may be performed according to the methods described herein. In some examples, aspects of the operations of 1930 may be performed by a mode management component as described with reference to FIGS. 10 through 13.

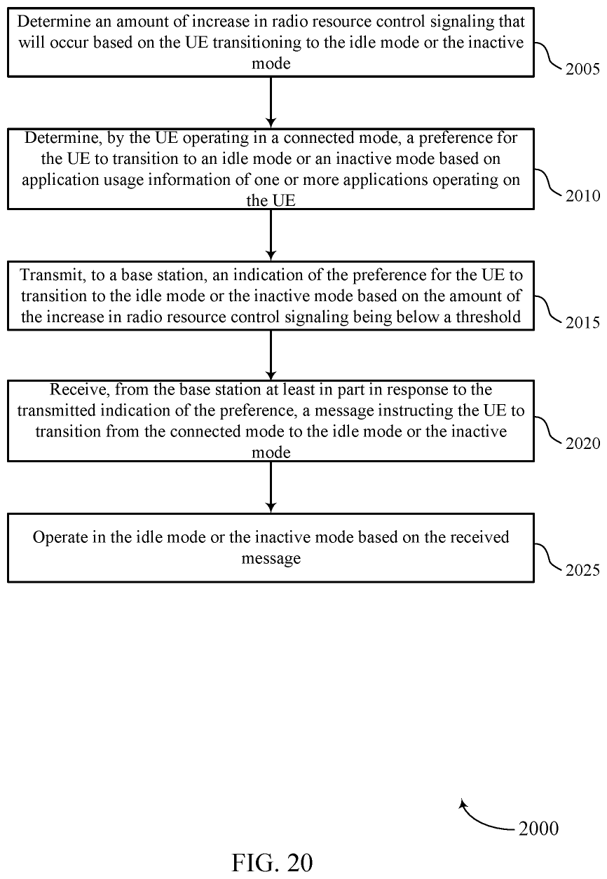

FIG. 20 shows a flowchart illustrating a method 2000 that supports application information aided fast dormancy in accordance with aspects of the present disclosure. The operations of method 2000 may be implemented by a UE 115 or its components as described herein. For example, the operations of method 2000 may be performed by a fast dormancy manager as described with reference to FIGS. 10 through 13. In some examples, a UE may execute a set of instructions to control the functional elements of the UE to perform the functions described herein. Additionally or alternatively, a UE may perform aspects of the functions described herein using special-purpose hardware.

At 2005, the UE may determine an amount of increase in RRC signaling that will occur based on the UE transitioning to the idle mode or the inactive mode. The operations of 2005 may be performed according to the methods described herein. In some examples, aspects of the operations of 2005 may be performed by a signaling manager as described with reference to FIGS. 10 through 13.

At 2010, the UE may determine, by the UE operating in a connected mode, a preference for the UE to transition to an idle mode or an inactive mode based on application usage information of one or more applications operating on the UE. The operations of 2010 may be performed according to the methods described herein. In some examples, aspects of the operations of 2010 may be performed by a preference manager as described with reference to FIGS. 10 through 13.

At 2015, the UE may transmit, to a base station, an indication of the preference for the UE to transition to the idle mode or the inactive mode based on the amount of the increase in RRC signaling being below a threshold. The operations of 2015 may be performed according to the methods described herein. In some examples, aspects of the operations of 2015 may be performed by an indication transmitter as described with reference to FIGS. 10 through 13.

At 2020, the UE may receive, from the base station at least in part in response to the transmitted indication of the preference, a message instructing the UE to transition from the connected mode to the idle mode or the inactive mode. The operations of 2020 may be performed according to the methods described herein. In some examples, aspects of the operations of 2020 may be performed by a message receiver as described with reference to FIGS. 10 through 13.

At 2025, the UE may operate in the idle mode or the inactive mode based on the received message. The operations of 2025 may be performed according to the methods described herein. In some examples, aspects of the operations of 2025 may be performed by a mode management component as described with reference to FIGS. 10 through 13.

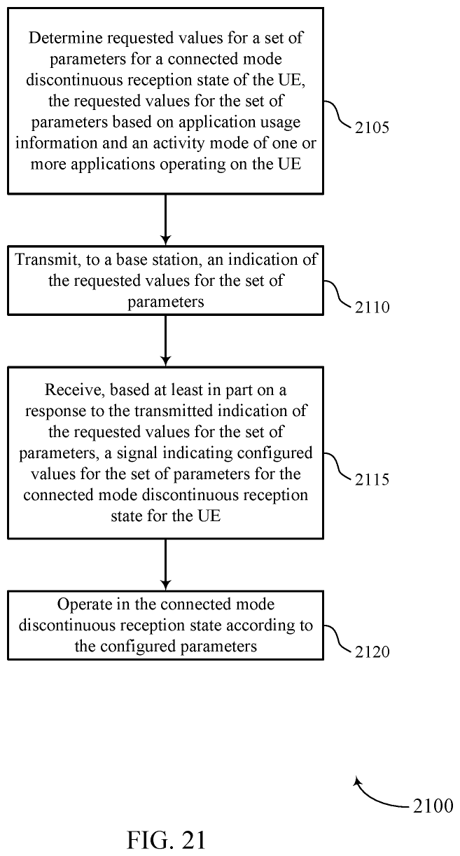

FIG. 21 shows a flowchart illustrating a method 2100 that supports application information-aided connected discontinuous reception negotiation in accordance with aspects of the present disclosure. The operations of method 2100 may be implemented by a UE 115 or its components as described herein. For example, the operations of method 2100 may be performed by a C-DRX adaptation manager as described with reference to FIGS. 14 through 17. In some examples, a UE may execute a set of instructions to control the functional elements of the UE to perform the functions described below. Additionally or alternatively, a UE may perform aspects of the functions described below using special-purpose hardware.

At 2105, the UE may determine requested values for a set of parameters for a C-DRX state of the UE, the requested values for the set of parameters based on application usage information and an activity mode of one or more applications operating on the UE. The operations of 2105 may be performed according to the methods described herein. In some examples, aspects of the operations of 2105 may be performed by a requested value manager as described with reference to FIGS. 14 through 17.

At 2110, the UE may transmit, to a base station, an indication of the requested values for the set of parameters. The operations of 2110 may be performed according to the methods described herein. In some examples, aspects of the operations of 2110 may be performed by an indication manager as described with reference to FIGS. 14 through 17.

At 2115, the UE may receive, at least in part a response to the transmitted indication of the requested values for the set of parameters, a signal indicating configured values for the set of parameters for the C-DRX state for the UE. The operations of 2115 may be performed according to the methods described herein. In some examples, aspects of the operations of 2115 may be performed by a configured value manager as described with reference to FIGS. 14 through 17.

At 2120, the UE may operate in the C-DRX state according to the configured parameters. The operations of 2120 may be performed according to the methods described herein. In some examples, aspects of the operations of 2120 may be performed by a DRX manager as described with reference to FIGS. 14 through 17.

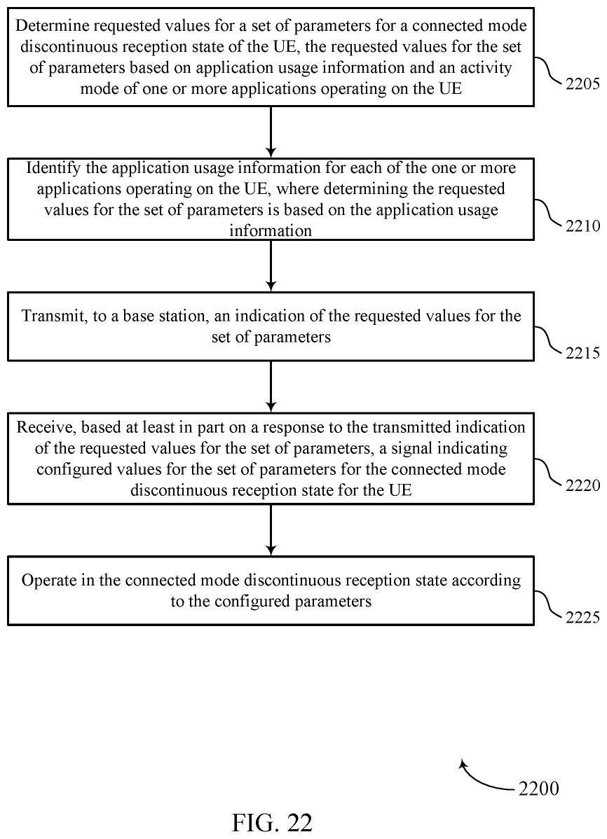

FIG. 22 shows a flowchart illustrating a method 2200 that supports application information-aided connected discontinuous reception negotiation in accordance with aspects of the present disclosure. The operations of method 2200 may be implemented by a UE 225 or its components as described herein. For example, the operations of method 2200 may be performed by a C-DRX adaptation manager as described with reference to FIGS. 14 through 17. In some examples, a UE may execute a set of instructions to control the functional elements of the UE to perform the functions described below. Additionally or alternatively, a UE may perform aspects of the functions described below using special-purpose hardware.

At 2205, the UE may determine requested values for a set of parameters for a C-DRX state of the UE, the requested values for the set of parameters based on application usage information and an activity mode of one or more applications operating on the UE. The operations of 2205 may be performed according to the methods described herein. In some examples, aspects of the operations of 2205 may be performed by a requested value manager as described with reference to FIGS. 14 through 17.

At 2210, the UE may identify the application usage information for each of the one or more applications operating on the UE, where determining the requested values for the set of parameters is based on the application usage information. The operations of 2210 may be performed according to the methods described herein. In some examples, aspects of the operations of 2210 may be performed by an application usage manager as described with reference to FIGS. 14 through 17.

At 2215, the UE may transmit, to a base station, an indication of the requested values for the set of parameters. The operations of 2215 may be performed according to the methods described herein. In some examples, aspects of the operations of 2215 may be performed by an indication manager as described with reference to FIGS. 14 through 17.

At 2220, the UE may receive, at least in part a response to the transmitted indication of the requested values for the set of parameters, a signal indicating configured values for the set of parameters for the C-DRX state for the UE. The operations of 2220 may be performed according to the methods described herein. In some examples, aspects of the operations of 2220 may be performed by a configured value manager as described with reference to FIGS. 14 through 17.

At 2225, the UE may operate in the C-DRX state according to the configured parameters. The operations of 2225 may be performed according to the methods described herein. In some examples, aspects of the operations of 2225 may be performed by a DRX manager as described with reference to FIGS. 14 through 17.

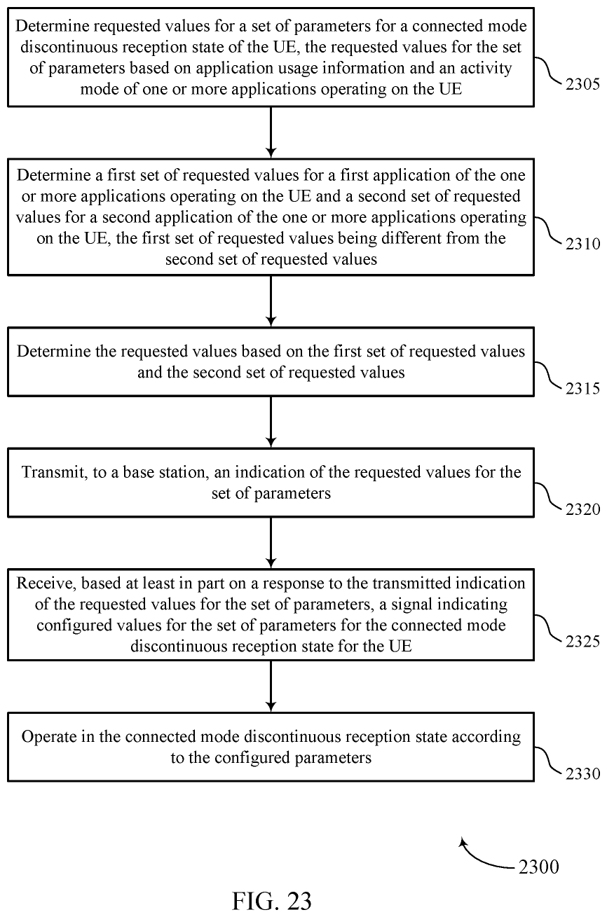

FIG. 23 shows a flowchart illustrating a method 2300 that supports application information-aided connected discontinuous reception negotiation in accordance with aspects of the present disclosure. The operations of method 2300 may be implemented by a UE 115 or its components as described herein. For example, the operations of method 2300 may be performed by a C-DRX adaptation manager as described with reference to FIGS. 14 through 17. In some examples, a UE may execute a set of instructions to control the functional elements of the UE to perform the functions described below. Additionally or alternatively, a UE may perform aspects of the functions described below using special-purpose hardware.

At 2305, the UE may determine requested values for a set of parameters for a C-DRX state of the UE, the requested values for the set of parameters based on application usage information and an activity mode of one or more applications operating on the UE. The operations of 2305 may be performed according to the methods described herein. In some examples, aspects of the operations of 2305 may be performed by a requested value manager as described with reference to FIGS. 14 through 17.

At 2310, the UE may determine a first set of requested values for a first application of the one or more applications operating on the UE and a second set of requested values for a second application of the one or more applications operating on the UE, the first set of requested values being different from the second set of requested values. The operations of 2310 may be performed according to the methods described herein. In some examples, aspects of the operations of 2310 may be performed by a multi-application usage manager as described with reference to FIGS. 14 through 17.

At 2315, the UE may determine the requested values based on the first set of requested values and the second set of requested values. The operations of 2315 may be performed according to the methods described herein. In some examples, aspects of the operations of 2315 may be performed by a multi-application usage manager as described with reference to FIGS. 14 through 17.

At 2320, the UE may transmit, to a base station, an indication of the requested values for the set of parameters. The operations of 2320 may be performed according to the methods described herein. In some examples, aspects of the operations of 2320 may be performed by an indication manager as described with reference to FIGS. 14 through 17.

At 2325, the UE may receive, at least in part a response to the transmitted indication of the requested values for the set of parameters, a signal indicating configured values for the set of parameters for the C-DRX state for the UE. The operations of 2325 may be performed according to the methods described herein. In some examples, aspects of the operations of 2325 may be performed by a configured value manager as described with reference to FIGS. 14 through 17.

At 2330, the UE may operate in the C-DRX state according to the configured parameters. The operations of 2330 may be performed according to the methods described herein. In some examples, aspects of the operations of 2330 may be performed by a DRX manager as described with reference to FIGS. 14 through 17.

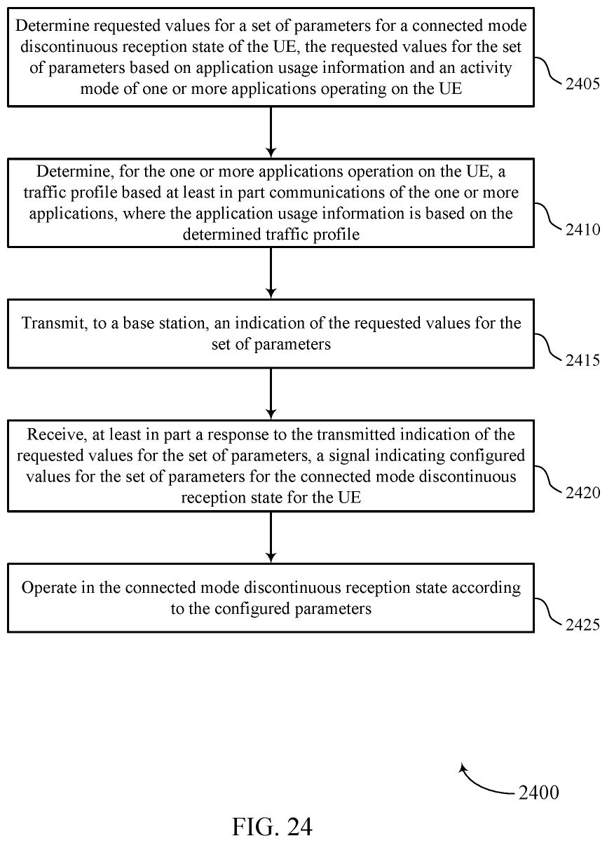

FIG. 24 shows a flowchart illustrating a method 2400 that supports application information-aided connected discontinuous reception negotiation in accordance with aspects of the present disclosure. The operations of method 2400 may be implemented by a UE 115 or its components as described herein. For example, the operations of method 2400 may be performed by a C-DRX adaptation manager as described with reference to FIGS. 14 through 17. In some examples, a UE may execute a set of instructions to control the functional elements of the UE to perform the functions described below. Additionally or alternatively, a UE may perform aspects of the functions described below using special-purpose hardware.

At 2405, the UE may determine requested values for a set of parameters for a C-DRX state of the UE, the requested values for the set of parameters based on application usage information and an activity mode of one or more applications operating on the UE. The operations of 2405 may be performed according to the methods described herein. In some examples, aspects of the operations of 2405 may be performed by a requested value manager as described with reference to FIGS. 14 through 17.

At 2410, the UE may determine, for the one or more applications operation on the UE, a traffic profile based at least in part communications of the one or more applications, where the application usage information is based on the determined traffic profile. The operations of 2410 may be performed according to the methods described herein. In some examples, aspects of the operations of 2410 may be performed by a traffic profile manager as described with reference to FIGS. 14 through 17.

At 2415, the UE may transmit, to a base station, an indication of the requested values for the set of parameters. The operations of 2415 may be performed according to the methods described herein. In some examples, aspects of the operations of 2415 may be performed by an indication manager as described with reference to FIGS. 14 through 17.

At 2420, the UE may receive, at least in part a response to the transmitted indication of the requested values for the set of parameters, a signal indicating configured values for the set of parameters for the C-DRX state for the UE. The operations of 2420 may be performed according to the methods described herein. In some examples, aspects of the operations of 2420 may be performed by a configured value manager as described with reference to FIGS. 14 through 17.

At 2425, the UE may operate in the C-DRX state according to the configured parameters. The operations of 2425 may be performed according to the methods described herein. In some examples, aspects of the operations of 2425 may be performed by a DRX manager as described with reference to FIGS. 14 through 17.

It should be noted that the methods described herein describe possible implementations, and that the operations and the steps may be rearranged or otherwise modified and that other implementations are possible. Further, aspects from two or more of the methods may be combined.

The following provides an overview of aspects of the present disclosure:

Aspect 1: A method for wireless communications at a UE, comprising: determining, by the UE operating in a connected mode, a preference for the UE to transition to an idle mode or an inactive mode based at least in part on application usage information of one or more applications operating on the UE; transmitting, to a base station, an indication of the preference for the UE to transition to the idle mode or the inactive mode; receiving, from the base station at least in part in response to the transmitted indication of the preference, a message instructing the UE to transition from the connected mode to the idle mode or the inactive mode; and operating in the idle mode or the inactive mode based at least in part on the received message.

Aspect 2: The method of aspect 1, wherein transmitting the indication of the preference comprises: transmitting, via RRC signaling, UE assistance information that includes the indication of the preference.

Aspect 3: The method of any of aspects 1 through 2, wherein receiving the message comprises: receiving a RRC connection release message that instructs the UE to transition from the connected mode to the idle mode or the inactive mode.

Aspect 4: The method of any of aspects 1 through 3, further comprising: identifying application usage information of the one or more applications operating on the UE; initiating a first inactivity timer and a second inactivity timer based at least in part on the application usage information, the second inactivity timer longer than the first inactivity timer; and operating in the idle mode or the inactive mode after expiration of the first inactivity timer and before expiration of the second inactivity timer.

Aspect 5: The method of any of aspects 1 through 4, further comprising: determining an amount of increase in RRC signaling that will occur based at least in part on the UE transitioning to the idle mode or the inactive mode; and transmitting the indication of the preference based at least in part on the amount of the increase in RRC signaling being below a threshold.

Aspect 6: The method of any of aspects 1 through 5, further comprising: identifying application usage information of one or more applications operating on the UE, wherein the application usage information comprises a name of the one or more applications, an identifier of the one or more applications, a foreground or background operation status of the one or more applications, a traffic profile of one or more applications, an activity mode of the one or more applications, or a combination thereof.

Aspect 7: The method of aspect 6, wherein the traffic profile of the one or more applications comprises one or more of traffic burst statistics, packet size for one or more data packets, or a combination thereof.

Aspect 8: The method of any of aspects 6 through 7, wherein the activity mode of the one or more applications comprises active traffic, web browsing, gaming, video streaming, music streaming, voice calling, video calling, virtual reality (VR), augmented reality (AR), or a combination thereof.

Aspect 9: The method of any of aspects 1 through 8, further comprising: determining UE operation information, wherein the preference for the UE to transition to the idle mode or the inactive mode is based at least in part on the UE operation information.

Aspect 10: The method of aspect 9, wherein the UE operation information comprises a number of active transmission control protocol connections, an amount of data for one or more transmissions by the UE or one or more receptions at the UE, a screen status of the UE, a battery status of the UE, a charging status of the UE, a wireless connectivity status of the UE, an increase in RRC signaling, or a combination thereof.

Aspect 11: The method of any of aspects 1 through 10, further comprising: receiving, at a RRC layer of the UE, the application usage information from an application layer of the UE.

Aspect 12: The method of any of aspects 1 through 11, further comprising: receiving, at a modem of the UE, the application usage information from an application processer of the UE, wherein the modem of the UE determines the preference for the UE to transition to the idle mode or the inactive mode and operates in the idle mode or the inactive mode based at least in part on the received message.

Aspect 13: An apparatus for wireless communications at a UE, comprising a processor; memory coupled with the processor; and instructions stored in the memory and executable by the processor to cause the apparatus to perform a method of any of aspects 1 through 12.

Aspect 14: An apparatus for wireless communications at a UE, comprising at least one means for performing a method of any of aspects 1 through 12.

Aspect 15: A non-transitory computer-readable medium storing code for wireless communications at a UE, the code comprising instructions executable by a processor to perform a method of any of aspects 1 through 12.

Aspect 16: A method for wireless communication at a UE, comprising: determining requested values for a set of parameters for a connected mode discontinuous reception state of the UE, the requested values for the set of parameters based at least in part on application usage information and an activity mode of one or more applications operating on the UE; transmitting, to a base station, an indication of the requested values for the set of parameters; receiving, at least in part a response to the transmitted indication of the requested values for the set of parameters, a signal indicating configured values for the set of parameters for the connected mode discontinuous reception state for the UE; and operating in the connected mode discontinuous reception state according to the configured values for the set of parameters.

Aspect 17: The method of aspect 16, further comprising: identifying the application usage information for each of the one or more applications operating on the UE, wherein determining the requested values for the set of parameters is based at least in part on the application usage information.

Aspect 18: The method of any of aspects 16 through 17, further comprising: determining a first set of requested values for a first application of the one or more applications operating on the UE and a second set of requested values for a second application of the one or more applications operating on the UE, the first set of requested values being different from the second set of requested values; and determining the requested values based at least in part on the first set of requested values and the second set of requested values.

Aspect 19: The method of any of aspects 16 through 18, wherein determining the requested values for the set of parameters comprises: determining, for the UE, the requested values for the set of parameters based at least in part on the application usage information and at least one of transmission control protocol (TCP) information of the UE, or application preferred values, or a screen status, or a battery status, or a charging status, or a wireless connection status, or a combination thereof.

Aspect 20: The method of any of aspects 16 through 19, wherein the application usage information is based at least in part on a traffic activity level, or a traffic type, or a priority level, or information received from an application processor, or an application type, or an application identifier, or a combination thereof, for each application.

Aspect 21: The method of any of aspects 16 through 20, further comprising: determining, for one or more applications operating on the UE, a traffic profile based at least in part communications of the one or more applications, wherein the application usage information is based at least in part on the determined traffic profile.

Aspect 22: The method of aspect 21, wherein the traffic profile of the one or more applications comprises one or more of traffic burst statistics, packet size for one or more data packets, or any combination thereof.

Aspect 23: The method of any of aspects 16 through 22, wherein the activity mode of the one or more applications comprises web browsing, gaming, video streaming, music streaming, video call, voice call, virtual reality, augmented reality, active state, or any combination thereof.

Aspect 24: The method of any of aspects 16 through 23, further comprising: determining that the activity mode is associated with an activity level below a threshold value; identifying a set of inactivity timers and a set of cycle durations, the set of inactivity timers comprising at least a first inactivity timer and a second inactivity timer longer than the first inactivity timer, and the set of cycle durations comprising at least a first cycle duration and a second cycle duration longer than the first cycle duration; and selecting, based at least in part on the activity level below the threshold value, the first inactivity timer and the second cycle duration for the requested values.

Aspect 25: The method of any of aspects 16 through 24, further comprising: determining that the activity mode is associated with an activity level that satisfies a threshold value; identifying a set of inactivity timers and a set of cycle durations, the set of inactivity timers comprising at least a first inactivity timer and a second inactivity timer longer than the first inactivity timer, and the set of cycle durations comprising at least a first cycle duration and a second cycle duration longer than the first cycle duration; and selecting, based at least in part on the activity level satisfying the threshold value, the second inactivity timer and the first cycle duration for the requested values.

Aspect 26: The method of any of aspects 16 through 25, wherein the set of parameters comprise at least one of an inactivity timer, or an ON duration, or a short cycle duration, or a long cycle duration, or a short cycle count, or a long cycle count, or a combination thereof, for the connected mode discontinuous reception state of the UE.

Aspect 27: The method of any of aspects 16 through 26, further comprising: receiving, at a radio resource control layer of the UE, the application usage information from an application layer of the UE.

Aspect 28: The method of any of aspects 16 through 27, further comprising: receiving, at a modem of the UE, the application usage information from an application processer of the UE, wherein the modem of the UE determines the requested values for the set of parameters and operates in the connected mode discontinuous reception state according to the configured values for the set of parameters.

Aspect 29: An apparatus for wireless communication at a UE, comprising a processor; memory coupled with the processor; and instructions stored in the memory and executable by the processor to cause the apparatus to perform a method of any of aspects 16 through 28.

Aspect 30: An apparatus for wireless communication at a UE, comprising at least one means for performing a method of any of aspects 16 through 28.

Aspect 31: A non-transitory computer-readable medium storing code for wireless communication at a UE, the code comprising instructions executable by a processor to perform a method of any of aspects 16 through 28.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a user equipment (UE), comprising:
determining, by the UE operating in a connected mode, a preference for the UE to transition to an idle mode or an inactive mode based at least in part on application usage information of one or more applications operating on the UE;
transmitting, to a base station, an indication of the preference for the UE to transition to the idle mode or the inactive mode;
receiving, from the base station at least in part in response to the transmitted indication of the preference, a message instructing the UE to transition from the connected mode to the idle mode or the inactive mode; and
operating in the idle mode or the inactive mode based at least in part on the received message.

2. The method of claim 1, wherein transmitting the indication of the preference comprises:
transmitting, via radio resource control signaling, UE assistance information that includes the indication of the preference.

3. The method of claim 1, wherein receiving the message comprises:
receiving a radio resource control connection release message that instructs the UE to transition from the connected mode to the idle mode or the inactive mode.

4. The method of claim 1, further comprising:
identifying application usage information of the one or more applications operating on the UE;
initiating a first inactivity timer and a second inactivity timer based at least in part on the application usage information, the second inactivity timer longer than the first inactivity timer; and
operating in the idle mode or the inactive mode after expiration of the first inactivity timer and before expiration of the second inactivity timer.

5. The method of claim 1, further comprising:
determining an amount of increase in radio resource control signaling that will occur based at least in part on the UE transitioning to the idle mode or the inactive mode; and
transmitting the indication of the preference based at least in part on the amount of the increase in radio resource control signaling being below a threshold.

6. The method of claim 1, further comprising:
identifying application usage information of one or more applications operating on the UE, wherein the application usage information comprises a name of the one or more applications, an identifier of the one or more applications, a foreground or background operation status of the one or more applications, a traffic profile of one or more applications, an activity mode of the one or more applications, or a combination thereof.

7. The method of claim 6, wherein the traffic profile of the one or more applications comprises one or more of traffic burst statistics, packet size for one or more data packets, or a combination thereof.

8. The method of claim 6, wherein the activity mode of the one or more applications comprises active traffic, web browsing, gaming, video streaming, music streaming, voice calling, video calling, virtual reality (VR), augmented reality (AR), or a combination thereof.

9. The method of claim 1, further comprising:
determining UE operation information, wherein the preference for the UE to transition to the idle mode or the inactive mode is based at least in part on the UE operation information.

10. The method of claim 9, wherein the UE operation information comprises a number of active transmission control protocol connections, an amount of data for one or more transmissions by the UE or one or more receptions at the UE, a screen status of the UE, a battery status of the UE, a charging status of the UE, a wireless connectivity status of the UE, an increase in radio resource control signaling, or a combination thereof.

11. The method of claim 1, further comprising:
receiving, at a radio resource control layer of the UE, the application usage information from an application layer of the UE.

12. The method of claim 1, further comprising:
receiving, at a modem of the UE, the application usage information from an application processer of the UE, wherein the modem of the UE determines the preference for the UE to transition to the idle mode or the inactive mode and operates in the idle mode or the inactive mode based at least in part on the received message.

13. A method for wireless communication at a user equipment (UE), comprising:
determining requested values for a set of parameters for a connected mode discontinuous reception state of the UE, the requested values for the set of parameters based at least in part on application usage information and an activity mode of one or more applications operating on the UE;
transmitting, to a base station, an indication of the requested values for the set of parameters;
receiving, at least in part a response to the transmitted indication of the requested values for the set of parameters, a signal indicating configured values for the set of parameters for the connected mode discontinuous reception state for the UE; and
operating in the connected mode discontinuous reception state according to the configured values for the set of parameters.

14. The method of claim 13, further comprising:
identifying the application usage information for each of the one or more applications operating on the UE, wherein determining the requested values for the set of parameters is based at least in part on the application usage information.

15. The method of claim 13, further comprising:
determining a first set of requested values for a first application of the one or more applications operating on the UE and a second set of requested values for a second application of the one or more applications operating on the UE, the first set of requested values being different from the second set of requested values; and
determining the requested values based at least in part on the first set of requested values and the second set of requested values.

16. The method of claim 13, wherein determining the requested values for the set of parameters comprises:
determining, for the UE, the requested values for the set of parameters based at least in part on the application usage information and at least one of transmission control protocol (TCP) information of the UE, or application preferred values, or a screen status, or a battery status, or a charging status, or a wireless connection status, or a combination thereof.

17. The method of claim 13, wherein the application usage information is based at least in part on a traffic activity level, or a traffic type, or a priority level, or information received from an application processor, or an application type, or an application identifier, or a combination thereof, for each application.

18. The method of claim 13, further comprising:
determining, for one or more applications operating on the UE, a traffic profile based at least in part communications of the one or more applications, wherein the application usage information is based at least in part on the determined traffic profile.

19. The method of claim 18, wherein the traffic profile of the one or more applications comprises one or more of traffic burst statistics, packet size for one or more data packets, or any combination thereof.

20. The method of claim 13, wherein the activity mode of the one or more applications comprises web browsing, gaming, video streaming, music streaming, video call, voice call, virtual reality, augmented reality, active state, or any combination thereof.

21. The method of claim 13, further comprising:
determining that the activity mode is associated with an activity level below a threshold value;
identifying a set of inactivity timers and a set of cycle durations, the set of inactivity timers comprising at least a first inactivity timer and a second inactivity timer longer than the first inactivity timer, and the set of cycle durations comprising at least a first cycle duration and a second cycle duration longer than the first cycle duration; and
selecting, based at least in part on the activity level below the threshold value, the first inactivity timer and the second cycle duration for the requested values.

22. The method of claim 13, further comprising:
determining that the activity mode is associated with an activity level that satisfies a threshold value;
identifying a set of inactivity timers and a set of cycle durations, the set of inactivity timers comprising at least a first inactivity timer and a second inactivity timer longer than the first inactivity timer, and the set of cycle durations comprising at least a first cycle duration and a second cycle duration longer than the first cycle duration; and
selecting, based at least in part on the activity level satisfying the threshold value, the second inactivity timer and the first cycle duration for the requested values.

23. The method of claim 13, wherein the set of parameters comprise at least one of an inactivity timer, or an ON duration, or a short cycle duration, or a long cycle duration, or a short cycle count, or a long cycle count, or a combination thereof, for the connected mode discontinuous reception state of the UE.

24. The method of claim 13, further comprising:
receiving, at a radio resource control layer of the UE, the application usage information from an application layer of the UE.

25. The method of claim 13, further comprising:
receiving, at a modem of the UE, the application usage information from an application processer of the UE, wherein the modem of the UE determines the requested values for the set of parameters and operates in the connected mode discontinuous reception state according to the configured values for the set of parameters.

26. An apparatus for wireless communications at a user equipment (UE), comprising:
a processor,
memory coupled with the processor; and
instructions stored in the memory and executable by the processor to cause the apparatus to:
determine, by the UE operating in a connected mode, a preference for the UE to transition to an idle mode or an inactive mode based at least in part on application usage information of one or more applications operating on the UE;
transmit, to a base station, an indication of the preference for the UE to transition to the idle mode or the inactive mode;
receive, from the base station at least in part in response to the transmitted indication of the preference, a message instructing the UE to transition from the connected mode to the idle mode or the inactive mode; and
operate in the idle mode or the inactive mode based at least in part on the received message.

27. The apparatus of claim 26, wherein the instructions to transmit the indication of the preference are executable by the processor to cause the apparatus to:
transmit, via radio resource control signaling, UE assistance information that includes the indication of the preference.

28. The apparatus of claim 26, wherein the instructions to receive the message are executable by the processor to cause the apparatus to:
receive a radio resource control connection release message that instructs the UE to transition from the connected mode to the idle mode or the inactive mode.

29. An apparatus for wireless communication at a user equipment (UE), comprising:
a processor,
memory coupled with the processor; and
instructions stored in the memory and executable by the processor to cause the apparatus to:
determine requested values for a set of parameters for a connected mode discontinuous reception state of the UE, the requested values for the set of parameters based at least in part on application usage information and an activity mode of one or more applications operating on the UE;
transmit, to a base station, an indication of the requested values for the set of parameters;
receive, at least in part a response to the transmitted indication of the requested values for the set of parameters, a signal indicating configured values for the set of parameters for the connected mode discontinuous reception state for the UE; and
operate in the connected mode discontinuous reception state according to the configured values for the set of parameters.

30. The apparatus of claim 29, wherein the instructions are further executable by the processor to cause the apparatus to:
identify the application usage information for each of the one or more applications operating on the UE, wherein determining the requested values for the set of parameters is based at least in part on the application usage information.
